(19) United States
(12) Patent Application Publication
(10) Pub. No.: US 2025/0048344 A1
(43) Pub. Date: Feb. 6, 2025

(54) METHOD FOR WIRELESS COMMUNICATION, TERMINAL DEVICE, AND NETWORK DEVICE

(71) Applicant: GUANGDONG OPPO MOBILE TELECOMMUNICATIONS CORP., LTD., Dongguan (CN)

(72) Inventors: Zhe LIU, Dongguan (CN); Jianfei CAO, Dongguan (CN)

(21) Appl. No.: 18/921,199

(22) Filed: Oct. 21, 2024

Related U.S. Application Data
(63) Continuation of application No. PCT/CN2022/089012, filed on Apr. 25, 2022.

(51) Int. Cl. H04W 72/0446; H04L 1/1867; H04W 72/21

(52) U.S. Cl. CPC H04W 72/0446; H04L 1/1896; H04W 72/21

(57) ABSTRACT

A method for wireless communication performed by a terminal device includes: receiving first TCI information, where the first TCI information is used to determine a first TCI state, or to determine a second and a third TC state; transmitting a first PUCCH at a first time domain position; in a case where the first TCI information is used to determine the first TCI state, determining whether to apply the first TCI state to transmit a first channel or signal after a second time domain position; or in a case where the first TCI information is used to determine the second TCI state and the third TCI state, determining whether to apply the second TCI state to transmit a first channel or signal after a third time domain position, and whether to apply the third TCI state to transmit the first channel or signal after a fourth time domain position.

### CROSS-REFERENCE TO RELATED APPLICATION

This application is a Continuation Application of International Application No. PCT/CN2022/089012 filed Apr. 25, 2022, which is incorporated herein by reference in its entirety.

### TECHNICAL FIELD

Embodiments of the present application relate to the communication field, and more specifically, to a method for wireless communication, a terminal device, and a network device.

### BACKGROUND

A new radio (New Radio, NR) system may perform repetition transmissions of a channel or signal based on a unified transmission configuration indicator (Transmission Configuration Indicator, TCI). During repetitions of the channel or signal, if a new TCI state takes effect, and at this time, whether to update the TCI state to ensure consistency in beam understanding between the terminal and the network, is a problem to be solved.

### SUMMARY

In a first aspect, a method for wireless communication is provided, and the method includes:
receiving, by a terminal device, first TCI information, where the first TCI information is used to determine a first TCI state, or the first TCI information is used to determine a second TCI state and a third TCI state;
transmitting, by the terminal device, a first PUCCH at a first time domain position, where the first PUCCH carries HARQ feedback information associated with the first TCI information;
in a case where the first TCI information is used to determine the first TCI state, determining, by the terminal device, whether to apply the first TCI state to transmit a first channel or signal after a second time domain position; or
in a case where the first TCI information is used to determine the second TCI state and the third TCI state, determining, by the terminal device, whether to apply the second TCI state to transmit a first channel or signal after a third time domain position, and whether to apply the third TCI state to transmit the first channel or signal after a fourth time domain position;
where the second time domain position is a starting position of a first time unit, and the first time unit is first one time unit after a first time interval after a last symbol occupied by the first PUCCH; the third time domain position is a starting position of a second time unit, and the second time unit is first one time unit after a second time interval after the last symbol occupied by the first PUCCH; and the fourth time domain position is a starting position of a third time unit, and the third time unit is first one time unit after a third time interval after the last symbol occupied by the first PUCCH.

In a second aspect, a method for wireless communication is provided, and the method includes:
transmitting, by a network device, first TCI information, where the first TCI information is used to determine a first TCI state, or the first TCI information is used to determine a second TCI state and a third TCI state;
receiving, by the network device, a first PUCCH transmitted by a terminal device at a first time domain position, where the first PUCCH carries HARQ feedback information associated with the first TCI information;
in a case where the first TCI information is used to determine the first TCI state, determining, by the network device, whether the terminal device applies the first TCI state to transmit a first channel or signal after a second time domain position; or
in a case where the first TCI information is used to determine the second TCI state and the third TCI state, determining, by the network device, whether the terminal device applies the second TC state to transmit a first channel or signal after a third time domain position, and whether the terminal device applies the third TCI state to transmit the first channel or signal after a fourth time domain position;
where the second time domain position is a starting position of a first time unit, and the first time unit is first one time unit after a first time interval after a last symbol occupied by the first PUCCH; the third time domain position is a starting position of a second time unit, and the second time unit is first one time unit after a second time interval after the last symbol occupied by the first PUCCH; and the fourth time domain position is a starting position of a third time unit, and the third time unit is first one time unit after a third time interval after the last symbol occupied by the first PUCCH.

In a third aspect, a method for wireless communication is provided, and the method includes:
receiving, by a terminal device, first TCI information, where the first TCI information is used to determine a first TCI state, or the first TCI information is used to determine a second TCI state and a third TCI state;
in a case where the first TCI information is used to determine the first TCI state, transmitting, by the terminal device, a first PUCCH, and determining, by the terminal device, an effective time of the first TCI state according to a time domain position of the first PUCCH; where the first PUCCH carries HARQ feedback information corresponding to m transmissions of a first channel, or the first PUCCH carries HARQ feedback information corresponding to a last transmission of m transmissions of a first channel, and m is a positive integer; or
in a case where the first TCI information is used to determine the second TCI state and the third TCI state, transmitting, by the terminal device, a second PUCCH and a third PUCCH, and determining, by the terminal device, an effective time of the second TCI state and an effective time of the third TCI state according to a time domain position of the second PUCCH and a time domain position of the third PUCCH; where the second PUCCH carries HARQ feedback information corresponding to all transmissions associated with the second TCI state in m transmissions of a first channel, and the third PUCCH carries HARQ feedback information corresponding to all transmissions associated with the third TCI state in the m transmissions of the first channel; or, the second PUCCH carries HARQ feedback information corresponding to a last transmission associated with the second TCI state in m transmissions of a first channel, and the third PUCCH carries HARQ feedback information corresponding to a last transmission associated with the third TCI state in the m transmissions of the first channel, and m is a positive integer.

In a fourth aspect, a method for wireless communication is provided, and the method includes:
transmitting, by a network device, first TCI information, where the first TCI information is used to determine a first TCI state, or the first TCI information is used to determine a second TCI state and a third TCI state;
in a case where the first TCI information is used to determine the first TCI state, receiving, by the network device, a first PUCCH; where the first PUCCH carries HARQ feedback information corresponding to m transmissions of a first channel, or the first PUCCH carries HARQ feedback information corresponding to a last transmission of m transmissions of a first channel, an effective time of the first TCI state is determined based on a time domain position of the first PUCCH, and m is a positive integer; or
in a case where the first TCI information is used to determine the second TCI state and the third TCI state, receiving, by the network device, a second PUCCH and a third PUCCH; where the second PUCCH carries HARQ feedback information corresponding to all transmissions associated with the second TCI state in m transmissions of a first channel, and the third PUCCH carries HARQ feedback information corresponding to all transmissions associated with the third TCI state in the m transmissions of the first channel; or, the second PUCCH carries HARQ feedback information corresponding to a last transmission associated with the second TCI state in m transmissions of a first channel, and the third PUCCH carries HARQ feedback information corresponding to a last transmission associated with the third TCI state in the m transmissions of the first channel, an effective time of the second TCI state and an effective time of the third TCI state are determined based on a time domain position of the second PUCCH and a time domain position of the third PUCCH, and m is an positive integer.

In a fifth aspect, a terminal device is provided, and is configured to perform the method in the aforementioned first aspect.

Specifically, the terminal device includes a functional module for performing the method in the aforementioned first aspect.

In a sixth aspect, a network device is provided, and is configured to perform the method in the aforementioned second aspect.

Specifically, the network device includes a functional module for performing the method in the aforementioned second aspect.

In a seventh aspect, a terminal device is provided, and is configured to perform the method in the aforementioned third aspect.

Specifically, the terminal device includes a functional module for performing the method in the aforementioned third aspect.

In an eighth aspect, a network device is provided, and is configured to perform the method in the aforementioned fourth aspect.

Specifically, the network device includes a functional module for performing the method in the aforementioned fourth aspect.

In a ninth aspect, a terminal device is provided, and includes a processor and a memory, the memory is configured to store a computer program, and the processor is configured to invoke and execute the computer program stored in the memory, to cause the terminal device to perform the method in the aforementioned first aspect.

In a tenth aspect, a network device is provided, and includes a processor and a memory, the memory is configured to store a computer program, and the processor is configured to invoke and execute the computer program stored in the memory, to cause the network device to perform the method in the aforementioned second aspect.

In an eleventh aspect, a terminal device is provided, and includes a processor and a memory, the memory is configured to store a computer program, and the processor is configured to invoke and execute the computer program stored in the memory, to cause the terminal device to perform the method in the aforementioned third aspect.

In a twelfth aspect, a network device is provided, and includes a processor and a memory, the memory is configured to store a computer program, and the processor is configured to invoke and execute the computer program stored in the memory, to cause the network device to perform the method in the aforementioned fourth aspect.

In a thirteenth aspect, an apparatus is provided, and is configured to implement the method in any one of the aforementioned first aspect to fourth aspect.

Specifically, the apparatus includes a processor which is configured to invoke and execute a computer program from a memory, to cause a device equipped with the apparatus to perform the method in any one of the aforementioned first aspect to fourth aspect.

In a fourteenth aspect, a non-transitory computer readable storage medium is provided, and is used for storing a computer program, which causes a computer to perform the method in any one of the aforementioned first aspect to fourth aspect.

In a fifteenth aspect, a computer program product is provided, and includes computer program instructions, which causes a computer to perform the method in any one of the aforementioned first aspect to fourth aspect.

In a sixteenth aspect, a computer program is provided, and the computer program, when executed on a computer, causes the computer to perform the method in any one of the aforementioned first aspect to fourth aspect.

### BRIEF DESCRIPTION OF THE DRAWINGS

FIG. 1 is a schematic diagram of a communication system architecture applied in the embodiments of the present application.

FIG. 2 is a schematic diagram of a BAT provided in the present application.

FIG. 3 is a schematic diagram in which DCI carries TCI information and MAC CE carries TCI information, provided in the present application.

FIG. 4 is a schematic flow chart of a method for wireless communication, provided according to the embodiments of the present application.

FIG. 5A is a schematic diagram in which DCI carries first TCI information, provided according to the embodiments of the present application.

FIG. 5B is another schematic diagram in which DCI carries first TCI information, provided according to the embodiments of the present application.

FIG. 5C is yet another schematic diagram in which DCI carries first TCI information, provided according to the embodiments of the present application.

FIG. 6A is still yet another schematic diagram in which DCI carries first TCI information, provided according to the embodiments of the present application.

FIG. 6B is still yet another schematic diagram in which DCI carries first TCI information, provided according to the embodiments of the present application.

FIG. 6C is still yet another schematic diagram in which DCI carries first TCI information, provided according to the embodiments of the present application.

FIG. 7 is yet another schematic diagram in which DCI carries first TCI information, provided according to the embodiments of the present application.

FIG. 8 is a schematic flow chart of another method for wireless communication, provided according to the embodiments of the present application.

FIG. 9 is a schematic flow chart of yet another method for wireless communication, provided according to the embodiments of the present application.

FIG. 10 is yet another schematic diagram in which DCI carries first TCI information, provided according to the embodiments of the present application.

FIG. 11 is yet another schematic diagram in which DCI carries first TCI information, provided according to the embodiments of the present application.

FIG. 12 is yet another schematic diagram in which DCI carries first TCI information, provided according to the embodiments of the present application.

FIG. 13 is yet another schematic diagram in which DCI carries first TCI information, provided according to the embodiments of the present application.

FIG. 14 is yet another schematic diagram in which DCI carries first TCI information, provided according to the embodiments of the present application.

FIG. 15 is a schematic flow chart of yet another method for wireless communication, provided according to the embodiments of the present application.

FIG. 16 is a schematic block diagram of a terminal device provided according to the embodiments of the present application.

FIG. 17 is a schematic block diagram of a network device provided according to the embodiments of the present application.

FIG. 18 is a schematic block diagram of another terminal device provided according to the embodiments of the present application.

FIG. 19 is a schematic block diagram of another network device provided according to the embodiments of the present application.

FIG. 20 is a schematic block diagram of a communication device provided according to the embodiments of the present application.

FIG. 21 is a schematic block diagram of an apparatus provided according to the embodiments of the present application.

FIG. 22 is a schematic block diagram of a communication system provided according to the embodiments of the present application.

### DETAILED DESCRIPTION

The technical solutions in the embodiments of the present application will be described in conjunction with the drawings in the embodiments of the present application, and apparently, the described embodiments are a part of the embodiments of the present application, but not all of the embodiments. For the embodiments of the present application, all other embodiments obtained by the ordinary skilled in the art belong to the protection scope of the present application.

The technical solutions of the embodiments of the present application may be applied to various communication systems, such as: a Global System of Mobile communication (GSM) system, a Code Division Multiple Access (CDMA) system, a Wideband Code Division Multiple Access (WCDMA) system, a General Packet Radio Service (GPRS), a Long Term Evolution (LTE) system, an Advanced long term evolution (LTE-A) system, a New Radio (NR) system, an evolution system of an NR system, an LTE-based access to unlicensed spectrum (LTE-U) system, an NR-based access to unlicensed spectrum (NR-U) system, a Non-Terrestrial communication Network (Non-Terrestrial Networks, NTN) system, a Universal Mobile Telecommunication System (UMTS), a Wireless Local Area Network (WLAN), an internet of things (IoT), a Wireless Fidelity (WiFi), a fifth-generation communication (5th-Generation, 5G) system, or other communication systems, etc.

Generally speaking, a number of connections supported by a traditional communication system is limited and is easy to implement, however, with the development of the communication technology, the mobile communication system will not only support the traditional communication, but also support, for example, Device to Device (D2D) communication, Machine to Machine (M2M) communication, Machine Type Communication (MTC), Vehicle to Vehicle (V2V) communication, or Vehicle to everything (V2X) communication, etc, and the embodiments of the present application may also be applied to these communication systems.

In some embodiments, the communication system in the embodiments of the present application may be applied to a carrier aggregation (CA) scenario, may also be applied to a dual connectivity (DC) scenario, and may also be applied to a standalone (SA) network deployment scenario, or applied to non-standalone (NSA) network deployment scenario.

In some embodiments, the communication system in the embodiments of the present application may be applied to an unlicensed spectrum, where the unlicensed spectrum may also be considered as a shared spectrum; or the communication system in the embodiments of the present application may also be applied to a licensed spectrum, where the licensed spectrum may also be considered as an unshared spectrum.

In some embodiments, the communication system in the embodiments of the present application may be applied to an FR1 frequency band (corresponding to a frequency band range of 410 MHz to 7.125 GHz), or may also be applied to an FR2 frequency band (corresponding to a frequency band range of 24.25 GHz to 52.6 GHz), or may also be applied to a new frequency band, such as a high frequency band corresponding to a frequency band range of 52.6 GHz to 71 GHz or corresponding to a frequency band range of 71 GHz to 114.25 GHz.

The embodiments of the present application describe various embodiments in conjunction with a network device and a terminal device, where the terminal device may also be referred to as a user equipment (UE), an access terminal, a user unit, a user station, a mobile station, a mobile platform, a remote station, a remote terminal, a mobile device, a user terminal, a terminal, a wireless communication device, a user agent or a user apparatus, etc.

The terminal device may be a station (STATION, STA) in the WLAN, may be a cellular phone, a cordless phone, a Session Initiation Protocol (SIP) phone, a Wireless Local Loop (WLL) station, or a personal digital assistant (PDA) device, a handheld device with a wireless communication function, a computing device or other processing devices connected to a wireless modem, a vehicle-mounted device, a wearable device, a terminal device in a next generation communication system such as in an NR network, or a terminal device in a Public Land Mobile Network (PLMN) network evolved in the future, etc.

In the embodiments of the present application, the terminal device may be deployed on land, which includes indoor or outdoor, in handheld, worn or vehicle-mounted; may also be deployed on water (e.g., on a ship, etc.); may also be deployed in the air (e.g., on an airplane, a balloon, a satellite, etc.).

In the embodiments of the present application, the terminal device may be a mobile phone, a pad, a computer with a wireless transceiving function, a Virtual Reality (VR) terminal device, an Augmented Reality (AR) terminal device, a wireless terminal device in industrial control, a wireless terminal device in self-driving, a wireless terminal device in remote medical, a wireless terminal device in smart grid, a wireless terminal device in transportation safety, a wireless terminal device in smart city, a wireless terminal device in smart home, a vehicle-mounted communication device, a wireless communication chip/application specific integrated circuit (ASIC)/system on chip (SoC), etc.

As an example but not a limitation, in the embodiments of the present application, the terminal device may also be a wearable device. The wearable device, which is also referred to as a wearable smart device, is a generic term for a device that can be worn, into which the daily wear is intelligently designed and developed by applying wearable technologies, such as glasses, gloves, watches, clothing, and shoes, etc. The wearable device is a portable device that is worn directly on the body, or integrated into the user's clothing or accessories. The wearable device is not just a hardware device, but also achieves powerful functions through software supporting, data interaction, and cloud interaction. A generalized wearable smart device includes for example, a smartwatch or smart glasses, etc., with full functions, large size, and entire or partial functions without relying on a smartphone, as well as, for example, a smart bracelet and smart jewelry for physical sign monitoring, which only focuses on a certain type of application function and needs to be used in conjunction with other devices such as a smartphone.

In the embodiments of the application, the network device may be a device used for communicating with a mobile device. The network device may be an Access Point (AP) in the WLAN, a base station (Base Transceiver Station, BTS) in the GSM or CDMA, may also be a base station (NodeB, NB) in the WCDMA, or may also be an evolutionary base station (Evolutionary Node B, eNB or eNodeB) in the LTE, or a relay station or an access point, or a vehicle-mounted device, a wearable device, and a network device or a base station (gNB) in an NR network, or a network device in the PLMN network evolved in the future or a network device in the NTN network, etc.

As an example but not a limitation, in the embodiments of the present application, the network device may have a mobile characteristic, for example, the network device may be a mobile device. In some embodiments, the network device may be a satellite or a balloon station. For example, the satellite may be a low earth orbit (LEO) satellite, a medium earth orbit (MEO) satellite, a geostationary earth orbit (GEO) satellite, a high elliptical orbit (HEO) satellite, etc. In some embodiments, the network device may also be a base station provided on land, water, and other places.

In the embodiments of the present application, the network device may provide a service for a cell, and the terminal device communicates with the network device through a transmission resource (such as a frequency domain resource, or a frequency spectrum resource) used by the cell. The cell may be a cell corresponding to the network device (such as the base station), the cell may belong to a macro base station or may also belong to a base station corresponding to a small cell, and the small cell here may include: a metro cell, a micro cell, a pico cell, a femto cell, etc, these small cells have characteristics of small coverage range and low transmission power, which are applicable for providing a data transmission service with high speed.

In the embodiments of the present application, a method for wireless communication is provided, which includes:
receiving, by a terminal device, first transmission configuration indicator (TCI) information, where the first TCI information is used to determine a first TCI state, or the first TCI information is used to determine a second TCI state and a third TCI state;
transmitting, by the terminal device, a first physical uplink control channel (PUCCH) at a first time domain position, where the first PUCCH carries hybrid automatic repeat request (HARQ) feedback information associated with the first TCI information;
in a case where the first TCI information is used to determine the first TCI state, determining, by the terminal device, whether to apply the first TCI state to transmit a first channel or signal after a second time domain position; or
in a case where the first TCI information is used to determine the second TCI state and the third TCI state, determining, by the terminal device, whether to apply the second TCI state to transmit a first channel or signal after a third time domain position, and whether to apply the third TCI state to transmit the first channel or signal after a fourth time domain position;
where the second time domain position is a starting position of a first time unit, and the first time unit is first one time unit after a first time interval after a last symbol occupied by the first PUCCH; the third time domain position is a starting position of a second time unit, and the second time unit is first one time unit after a second time interval after the last symbol occupied by the first PUCCH; and the fourth time domain position is a starting position of a third time unit, and the third time unit is first one time unit after a third time interval after the last symbol occupied by the first PUCCH.

In an implementation, in the case where the first TCI information is used to determine the first TCI state, the first TCI state is a joint TCI state, or the first TCI state is an uplink TCI state, or the first TCI state is a downlink TCI state.

In an implementation, in a case where the first TCI state is the uplink TCI state, the first TCI information is further used to determine a downlink TCI state; or in a case where the first TCI state is the downlink TCI state, the first TCI information is further used to determine an uplink TCI state.

In an implementation, determining, by the terminal device, whether to apply the first TCI state to transmit the first channel or signal after the second time domain position includes:
if a starting position of a first transmission of m transmissions of the first channel or signal is located before the second time domain position, determining, by the terminal device, that second TCI information is applied to all the m transmissions of the first channel or signal, where the second TCI information is TCI information applied by the terminal device before the second time domain position, and m is a positive integer.

In an implementation, determining, by the terminal device, whether to apply the first TCI state to transmit the first channel or signal after the second time domain position includes:
if starting positions of first ml transmissions of m transmissions of the first channel or signal are located before the second time domain position, and starting positions of last m-ml transmissions of the m transmissions of the first channel or signal are located after the second time domain position, determining, by the terminal device, to apply the first TCI state to transmit the first channel or signal after the second time domain position;
where the first ml transmissions of the m transmissions of the first channel or signal apply second TCI information, and the last m-ml transmissions of the m transmissions of the first channel or signal apply the first TCI state, the second TCI information is TCI information applied by the terminal device before the second time domain position, and m and ml are both positive integers.

In an implementation, a time interval between an ml-th transmission and an (m1+1)-th transmission of the first channel or signal is greater than a beam switching time.

In an implementation, determining, by the terminal device, whether to apply the first TCI state to transmit the first channel or signal after the second time domain position includes:
if starting positions of first ml transmissions of m transmissions of the first channel or signal are located before the second time domain position, and starting positions of last m-ml transmissions of the m transmissions of the first channel or signal are located after the second time domain position, determining, by the terminal device, to discard the last m-ml transmissions of the first channel or signal located after the second time domain position;
where the first ml transmissions of the m transmissions of the first channel or signal apply second TCI information, the second TCI information is TCI information applied by the terminal device before the second time domain position, and m and ml are both positive integers.

In an implementation, determining, by the terminal device, whether to apply the first TCI state to transmit the first channel or signal after the second time domain position includes:
if starting positions of first ml transmissions of m transmissions of the first channel or signal are located before the second time domain position, and starting positions of last m-ml transmissions of the m transmissions of the first channel or signal are located after the second time domain position, determining, by the terminal device, to delay an application time of the first TCI state to an end of the last m-ml transmissions of the first channel or signal, or determining, by the terminal device, to delay an application time of the first TCI state to a first time unit after an end of transmissions of the first channel or signal;
where the first ml transmissions of the m transmissions of the first channel or signal apply second TCI information, the second TCI information is TCI information applied by the terminal device before the second time domain position, and m and ml are both positive integers.

In an implementation, in the case where the first TCI information is used to determine the second TCI state and the third TCI state, the second time interval is associated with a first spatial parameter, and the third time interval is associated with a second spatial parameter.

In an implementation, the second TCI state and the third TCI state are two uplink TCI states, and the second TCI state and the third TCI state are respectively applied to different transmission layers of an uplink channel, or the second TCI state and the third TCI state are respectively applied to different repetition transmissions of an uplink channel; or
the second TCI state and the third TCI state are two downlink TCI states, and the second TCI state and the third TCI state are respectively applied to different transmission layers of a downlink channel, or the second TCI state and the third TCI state are respectively applied to different repetition transmissions of a downlink channel; or
the second TCI state and the third TCI state are two joint TCI states, and the second TCI state and the third TCI state are respectively applied to different transmission layers of an uplink channel and/or a downlink channel, or the second TCI state and the third TCI state are respectively applied to different repetition transmissions of an uplink channel and/or a downlink channel.

In an implementation, determining, by the terminal device, whether to apply the second TCI state to transmit the first channel or signal after the third time domain position, and whether to apply the third TCI state to transmit the first channel or signal after the fourth time domain position includes:
if a starting position of a first transmission of m transmissions of the first channel or signal is earlier than an earlier time domain position in the third time domain position and the fourth time domain position in time domain, determining, by the terminal device, that the m transmissions of the first channel or signal all apply second TCI information;
where the second TCI information is TCI information applied by the terminal device before the earlier time domain position in the third time domain position and the fourth time domain position in time domain, and m is a positive integer.

In an implementation, determining, by the terminal device, whether to apply the second TCI state to transmit the first channel or signal after the third time domain position, and whether to apply the third TCI state to transmit the first channel or signal after the fourth time domain position includes:
if a first transmission associated with the first spatial parameter in m transmissions of the first channel or signal is before the third time domain position, determining, by the terminal device, that the m transmissions of the first channel or signal all apply second TCI information; or
if a first transmission associated with the second spatial parameter in m transmissions of the first channel or signal is before the fourth time domain position, determining, by the terminal device, that the m transmissions of the first channel or signal all apply second TCI information;
where the second TCI information is TCI information applied by the terminal device before an earlier time domain position in the third time domain position and the fourth time domain position in time domain, and m is a positive integer.

In an implementation, determining, by the terminal device, whether to apply the second TCI state to transmit the first channel or signal after the third time domain position, and whether to apply the third TCI state to transmit the first channel or signal after the fourth time domain position includes:
determining, by the terminal device, that a transmission located after the third time domain position and associated with the first spatial parameter in m transmissions of the first channel or signal applies the second TCI state, and that a transmission located after the fourth time domain position and associated with the second spatial parameter in the m transmissions of the first channel or signal applies the third TCI state;
where m is a positive integer.

In an implementation, a time interval between two adjacent transmissions associated with a same spatial parameter is greater than a beam switching time.

In an implementation, determining, by the terminal device, whether to apply the second TCI state to transmit the first channel or signal after the third time domain position, and whether to apply the third TCI state to transmit the first channel or signal after the fourth time domain position includes:
determining, by the terminal device, to discard a transmission located after the third time domain position and associated with the first spatial parameter in m transmissions of the first channel or signal, and to discard a transmission located after the fourth time domain position and associated with the second spatial parameter in the m transmissions of the first channel or signal;
where m is a positive integer.

In an implementation, determining, by the terminal device, whether to apply the second TCI state to transmit the first channel or signal after the third time domain position, and whether to apply the third TCI state to transmit the first channel or signal after the fourth time domain position includes:
determining, by the terminal device, to delay an application time of the second TCI state and an application time of the third TCI state to an end of m transmissions of the first channel or signal; or
determining, by the terminal device, to delay an application time of the second TCI state to an end of a transmission associated with the first spatial parameter in m transmissions of the first channel or signal, or determining, by the terminal device, to delay an application time of the second TCI state to a first time unit after an end of a transmission associated with the first spatial parameter in the m transmissions of the first channel or signal; and determining, by the terminal device, to delay an application time of the third TCI state to an end of a transmission associated with the second spatial parameter in the m transmissions of the first channel or signal, or determining, by the terminal device, to delay an application time of the third TCI state to a first time unit after an end of a transmission associated with the second spatial parameter in the m transmissions of the first channel or signal;
where m is a positive integer.

In an implementation, the first TCI information is carried by downlink control information (DCI), or the first TCI information is carried by a media access control layer control element (MAC CE).

In an implementation, in a case where the first TCI information is carried by the DCI, the first time interval is Y1 time units; or, in a case where the first TCI information is carried by the MAC CE, the first time interval is an effective time of the MAC CE; or
the second time interval is Y2 time units, and/or the third time interval is Y3 time units; where Y1, Y2 and Y3 are all positive integers.

In an implementation, Y1 is agreed by a protocol, or Y1 is configured by a network device according to a minimum beam application time supported by the terminal device; or
Y2 and Y3 are agreed by a protocol, or Y2 and Y3 are configured by the network device according to a minimum beam application time supported by the terminal device.

In an implementation, the time unit includes at least one of: a slot, a symbol, a frame, or a subframe.

In the embodiments of the present application, another method for wireless communication is provided, which includes:
transmitting, by a network device, first transmission configuration indicator (TCI) information, where the first TCI information is used to determine a first TCI state, or the first TCI information is used to determine a second TCI state and a third TCI state;
receiving, by the network device, a first physical uplink control channel (PUCCH) transmitted by a terminal device at a first time domain position, where the first PUCCH carries hybrid automatic repeat request (HARQ) feedback information associated with the first TCI information;
in a case where the first TCI information is used to determine the first TCI state, determining, by the network device, whether the terminal device applies the first TCI state to transmit a first channel or signal after a second time domain position; or
in a case where the first TCI information is used to determine the second TCI state and the third TCI state, determining, by the network device, whether the terminal device applies the second TCI state to transmit a first channel or signal after a third time domain position, and whether the terminal device applies the third TCI state to transmit the first channel or signal after a fourth time domain position;
where the second time domain position is a starting position of a first time unit, and the first time unit is first one time unit after a first time interval after a last symbol occupied by the first PUCCH; the third time domain position is a starting position of a second time unit, and the second time unit is first one time unit after a second time interval after the last symbol occupied by the first PUCCH; and the fourth time domain position is a starting position of a third time unit, and the third time unit is first one time unit after a third time interval after the last symbol occupied by the first PUCCH.

In an implementation, in the case where the first TCI information is used to determine the first TCI state, the first TCI state is a joint TCI state, or the first TCI state is an uplink TCI state, or the first TCI state is a downlink TCI state.

In an implementation, in a case where the first TCI state is the uplink TCI state, the first TCI information is further used to determine a downlink TCI state; or in a case where the first TCI state is the downlink TCI state, the first TCI information is further used to determine an uplink TCI state.

In an implementation, determining, by the network device, whether the terminal device applies the first TCI state to transmit the first channel or signal after the second time domain position includes:
if a starting position of a first transmission of m transmissions of the first channel or signal is located before the second time domain position, determining, by the network device, that the terminal device applies second TCI information in all the m transmissions of the first channel or signal, where the second TCI information is TCI information applied by the terminal device before the second time domain position, and m is a positive integer.

In an implementation, determining, by the network device, whether the terminal device applies the first TCI state to transmit the first channel or signal after the second time domain position includes:
if starting positions of first ml transmissions of m transmissions of the first channel or signal are located before the second time domain position, and starting positions of last m-ml transmissions of the m transmissions of the first channel or signal are located after the second time domain position, determining, by the network device, that the terminal device applies the first TCI state to transmit the first channel or signal after the second time domain position;
where the first ml transmissions of the m transmissions of the first channel or signal apply second TCI information, and the last m-ml transmissions of the m transmissions of the first channel or signal apply the first TCI state, the second TCI information is TCI information applied by the terminal device before the second time domain position, and m and ml are both positive integers.

In an implementation, a time interval between an ml-th transmission and an (m1+1)-th transmission of the first channel or signal is greater than a beam switching time.

In an implementation, determining, by the network device, whether the terminal device applies the first TCI state to transmit the first channel or signal after the second time domain position includes:
if starting positions of first ml transmissions of m transmissions of the first channel or signal are located before the second time domain position, and starting positions of last m−m1 transmissions of the m transmissions of the first channel or signal are located after the second time domain position, determining, by the network device, that the terminal device discards the last m−m1 transmissions of the first channel or signal located after the second time domain position;
where the first ml transmissions of the m transmissions of the first channel or signal apply second TCI information, the second TCI information is TCI information applied by the terminal device before the second time domain position, and m and ml are both positive integers.

In an implementation, determining, by the network device, whether the terminal device applies the first TCI state to transmit the first channel or signal after the second time domain position includes:
if starting positions of first ml transmissions of m transmissions of the first channel or signal are located before the second time domain position, and starting positions of last m-ml transmissions of the m transmissions of the first channel or signal are located after the second time domain position, determining, by the network device, that the terminal device delays an application time of the first TCI state to an end of the last m-ml transmissions of the first channel or signal, or determining, by the network device, that the terminal device delays an application time of the first TCI state to a first time unit after an end of transmissions of the first channel or signal;
where the first ml transmissions of the m transmissions of the first channel or signal apply second TCI information, the second TCI information is TCI information applied by the terminal device before the second time domain position, and m and ml are both positive integers.

In an implementation, in the case where the first TCI information is used to determine the second TCI state and the third TCI state, the second time interval is associated with a first spatial parameter, and the third time interval is associated with a second spatial parameter.

In an implementation, the second TCI state and the third TCI state are two uplink TCI states, and the second TCI state and the third TCI state are respectively applied to different transmission layers of an uplink channel, or the second TCI state and the third TCI state are respectively applied to different repetition transmissions of an uplink channel; or
the second TCI state and the third TCI state are two downlink TCI states, and the second TCI state and the third TCI state are respectively applied to different transmission layers of a downlink channel, or the second TCI state and the third TCI state are respectively applied to different repetition transmissions of a downlink channel; or
the second TCI state and the third TCI state are two joint TCI states, and the second TCI state and the third TCI state are respectively applied to different transmission layers of an uplink channel and/or a downlink channel, or the second TCI state and the third TCI state are respectively applied to different repetition transmissions of an uplink channel and/or a downlink channel.

In an implementation, determining, by the network device, whether the terminal device applies the second TCI state to transmit the first channel or signal after the third time domain position, and whether the terminal device applies the third TCI state to transmit the first channel or signal after the fourth time domain position includes:
if a starting position of a first transmission of m transmissions of the first channel or signal is earlier than an earlier time domain position in the third time domain position and the fourth time domain position in time domain, determining, by the network device, that the terminal device applies second TCI information in all the m transmissions of the first channel or signal;
where the second TCI information is TCI information applied by the terminal device before the earlier time domain position in the third time domain position and the fourth time domain position in time domain, and m is a positive integer.

In an implementation, determining, by the network device, whether the terminal device applies the second TCI state to transmit the first channel or signal after the third time domain position, and whether the terminal device applies the third TCI state to transmit the first channel or signal after the fourth time domain position includes:
if a first transmission associated with the first spatial parameter in m transmissions of the first channel or signal is before the third time domain position, determining, by the network device, that the terminal device applies second TCI information in all the m transmissions of the first channel or signal; or
if a first transmission associated with the second spatial parameter in m transmissions of the first channel or signal is before the fourth time domain position, determining, by the network device, that the terminal device applies second TCI information in all the m transmissions of the first channel or signal;
where the second TCI information is TCI information applied by the terminal device before an earlier time domain position in the third time domain position and the fourth time domain position in time domain, and m is a positive integer.

In an implementation, determining, by the network device, whether the terminal device applies the second TCI state to transmit the first channel or signal after the third time domain position, and whether the terminal device applies the third TCI state to transmit the first channel or signal after the fourth time domain position includes:
determining, by the network device, that the terminal device applies the second TC state in a transmission located after the third time domain position and associated with the first spatial parameter in m transmissions of the first channel or signal, and applies the third TCI state in a transmission located after the fourth time domain position and associated with the second spatial parameter in the m transmissions of the first channel or signal;
where m is a positive integer.

In an implementation, a time interval between two adjacent transmissions associated with a same spatial parameter is greater than a beam switching time.

In an implementation, determining, by the network device, whether the terminal device applies the second TCI state to transmit the first channel or signal after the third time domain position, and whether the terminal device applies the third TCI state to transmit the first channel or signal after the fourth time domain position includes:
determining, by the network device, that the terminal device discards a transmission located after the third time domain position and associated with the first spatial parameter in m transmissions of the first channel or signal, and discards a transmission located after the fourth time domain position and associated with the second spatial parameter in the m transmissions of the first channel or signal;
where m is a positive integer.

In an implementation, determining, by the network device, whether the terminal device applies the second TCI state to transmit the first channel or signal after the third time domain position, and whether the terminal device applies the third TCI state to transmit the first channel or signal after the fourth time domain position includes:
determining, by the network device, that the terminal device delays an application time of the second TCI state and an application time of the third TCI state to an end of m transmissions of the first channel or signal; or
determining, by the network device, that the terminal device delays an application time of the second TCI state to an end of a transmission associated with the first spatial parameter in m transmissions of the first channel or signal, or determining, by the network device, that the terminal device delays an application time of the second TCI state to a first time unit after an end of a transmission associated with the first spatial parameter in the m transmissions of the first channel or signal; and determining, by the network device, that the terminal device delays an application time of the third TCI state to an end of a transmission associated with the second spatial parameter in the m transmissions of the first channel or signal, or determining, by the network device, that the terminal device delays an application time of the third TCI state to a first time unit after an end of a transmission associated with the second spatial parameter in the m transmissions of the first channel or signal;
where m is a positive integer.

In an implementation, the first TCI information is carried by downlink control information (DCI), or the first TCI information is carried by a media access control layer control element (MAC CE).

In an implementation, in a case where the first TCI information is carried by the DCI, the first time interval is Y1 time units; or, in a case where the first TCI information is carried by the MAC CE, the first time interval is an effective time of the MAC CE; or
the second time interval is Y2 time units, and/or the third time interval is Y3 time units; where Y1, Y2 and Y3 are all positive integers.

In an implementation, Y1 is agreed by a protocol, or Y1 is configured by a network device according to a minimum beam application time supported by the terminal device; or Y2 and Y3 are agreed by a protocol, or Y2 and Y3 are configured by the network device according to a minimum beam application time supported by the terminal device.

In an implementation, the time unit includes at least one of: a slot, a symbol, a frame, or a subframe.

In the embodiments of the present application, another method for wireless communication is provided, which includes:
receiving, by a terminal device, first transmission configuration indicator (TCI) information, where the first TCI information is used to determine a first TCI state, or the first TCI information is used to determine a second TCI state and a third TCI state;
in a case where the first TCI information is used to determine the first TCI state, transmitting, by the terminal device, a first physical uplink control channel (PUCCH), and determining, by the terminal device, an effective time of the first TCI state according to a time domain position of the first PUCCH; where the first PUCCH carries hybrid automatic repeat request (HARQ) feedback information corresponding to m transmissions of a first channel, or the first PUCCH carries HARQ feedback information corresponding to a last transmission of m transmissions of a first channel, and m is a positive integer; or
in a case where the first TCI information is used to determine the second TCI state and the third TCI state, transmitting, by the terminal device, a second PUCCH and a third PUCCH, and determining, by the terminal device, an effective time of the second TCI state and an effective time of the third TCI state according to a time domain position of the second PUCCH and a time domain position of the third PUCCH; where the second PUCCH carries HARQ feedback information corresponding to all transmissions associated with the second TCI state in m transmissions of a first channel, and the third PUCCH carries HARQ feedback information corresponding to all transmissions associated with the third TCI state in the m transmissions of the first channel; or, the second PUCCH carries HARQ feedback information corresponding to a last transmission associated with the second TCI state in m transmissions of a first channel, and the third PUCCH carries HARQ feedback information corresponding to a last transmission associated with the third TCI state in the m transmissions of the first channel, and m is a positive integer.

In an implementation, in the case where the first TCI information is used to determine the first TCI state, the first TCI state is a joint TCI state, or the first TCI state is an uplink TCI state, or the first TCI state is a downlink TCI state.

In an implementation, in a case where the first TCI state is the uplink TCI state, the first TCI information is further used to determine a downlink TCI state; or
in a case where the first TCI state is the downlink TCI state, the first TCI information is further used to determine an uplink TCI state.

In an implementation, determining, by the terminal device, the effective time of the first TCI state according to the time domain position of the first PUCCH includes:
determining, by the terminal device, that the first TCI state is effective at a first time domain position;
where the first time domain position is a starting position of a first time unit, and the first time unit is first one time unit after a first time interval after a last symbol occupied by the first PUCCH.

In an implementation, in the case where the first TCI information is used to determine the second TCI state and the third TCI state,
the second TCI state and the third TCI state are two uplink TCI states, and the second TCI state and the third TCI state are respectively applied to different transmission layers of an uplink channel, or the second TCI state and the third TCI state are respectively applied to different repetition transmissions of an uplink channel; or
the second TCI state and the third TCI state are two downlink TCI states, and the second TCI state and the third TCI state are respectively applied to different transmission layers of a downlink channel, or the second TCI state and the third TCI state are respectively applied to different repetition transmissions of a downlink channel; or
the second TCI state and the third TCI state are two joint TCI states, and the second TCI state and the third TCI state are respectively applied to different transmission layers of an uplink channel and/or a downlink channel, or the second TCI state and the third TCI state are respectively applied to different repetition transmissions of an uplink channel and/or a downlink channel.

In an implementation, determining, by the terminal device, the effective time of the second TCI state and the effective time of the third TCI state according to the time domain position of the second PUCCH and the time domain position of the third PUCCH includes:
if the time domain position of the second PUCCH is located after the time domain position of the third PUCCH, determining, by the terminal device, that the second TCI state is effective at a second time domain position and the third TCI state is not effective, where the second time domain position is a starting position of a second time unit, and the second time unit is first one time unit after a second time interval after a last symbol occupied by the second PUCCH; or
if the time domain position of the second PUCCH is located after the time domain position of the third PUCCH, determining, by the terminal device, that the third TCI state is effective at a third time domain position and the second TCI state is not effective, where the third time domain position is a starting position of a third time unit, and the third time unit is first one time unit after a third time interval after a last symbol of the third PUCCH.

In an implementation, the second time interval and the third time interval are associated with different spatial parameters, respectively.

In an implementation, determining, by the terminal device, the effective time of the second TCI state and the effective time of the third TCI state according to the time domain position of the second PUCCH and the time domain position of the third PUCCH includes:
determining, by the terminal device, that the second TCI state is effective at a fourth time domain position, and the third TCI state is effective at a fifth time domain position;
where the fourth time domain position is a starting position of a fourth time unit, and the fourth time unit is first one time unit after a fourth time interval after a last symbol occupied by the second PUCCH; the fifth time domain position is a starting position of a fifth time unit, and the fifth time unit is first one time unit after a fifth time interval after a last symbol occupied by the third PUCCH.

In an implementation, the fourth time interval and the fifth time interval are associated with different spatial parameters, respectively.

In an implementation, the time unit includes at least one of: a slot, a symbol, a frame, or a subframe.

In an implementation, the first channel is a physical downlink shared channel (PDSCH).

In the embodiments of the present application, another method for wireless communication is provided, which includes:
transmitting, by a network device, first transmission configuration indicator (TCI) information, where the first TCI information is used to determine a first TCI state, or the first TCI information is used to determine a second TCI state and a third TCI state;
in a case where the first TCI information is used to determine the first TCI state, receiving, by the network device, a first physical uplink control channel (PUCCH); where the first PUCCH carries hybrid automatic repeat request (HARQ) feedback information corresponding to m transmissions of a first channel, or the first PUCCH carries HARQ feedback information corresponding to a last transmission of m transmissions of a first channel, an effective time of the first TCI state is determined based on a time domain position of the first PUCCH, and m is a positive integer; or
in a case where the first TCI information is used to determine the second TCI state and the third TCI state, receiving, by the network device, a second PUCCH and a third PUCCH; where the second PUCCH carries HARQ feedback information corresponding to all transmissions associated with the second TCI state in m transmissions of a first channel, and the third PUCCH carries HARQ feedback information corresponding to all transmissions associated with the third TCI state in the m transmissions of the first channel; or, the second PUCCH carries HARQ feedback information corresponding to a last transmission associated with the second TCI state in m transmissions of a first channel, and the third PUCCH carries HARQ feedback information corresponding to a last transmission associated with the third TCI state in the m transmissions of the first channel, an effective time of the second TCI state and an effective time of the third TCI state are determined based on a time domain position of the second PUCCH and a time domain position of the third PUCCH, and m is an positive integer.

In an implementation, in the case where the first TCI information is used to determine the first TCI state, the first TCI state is a joint TCI state, or the first TCI state is an uplink TCI state, or the first TCI state is a downlink TCI state.

In an implementation, in a case where the first TCI state is the uplink TCI state, the first TCI information is further used to determine a downlink TCI state; or in a case where the first TCI state is the downlink TCI state, the first TCI information is further used to determine an uplink TCI state.

In an implementation, in the case where the first TCI information is used to determine the first TCI state, the first TCI state is effective at a first time domain position, where the first time domain position is a starting position of a first time unit, and the first time unit is first one time unit after a first time interval after a last symbol occupied by the first PUCCH.

In an implementation, in the case where the first TCI information is used to determine the second TCI state and the third TCI state,
the second TCI state and the third TCI state are two uplink TCI states, and the second TCI state and the third TCI state are respectively applied to different transmission layers of an uplink channel, or the second TCI state and the third TCI state are respectively applied to different repetition transmissions of an uplink channel; or,
the second TCI state and the third TCI state are two downlink TCI states, and the second TCI state and the third TCI state are respectively applied to different transmission layers of a downlink channel, or the second TCI state and the third TCI state are respectively applied to different repetition transmissions of a downlink channel; or
the second TCI state and the third TCI state are two joint TCI states, and the second TCI state and the third TCI state are respectively applied to different transmission layers of an uplink channel and/or a downlink channel, or the second TCI state and the third TCI state are respectively applied to different repetition transmissions of an uplink channel and/or a downlink channel.

In an implementation, in the case where the first TCI information is used to determine the second TCI state and the third TCI state, if the time domain position of the second PUCCH is located after the time domain position of the third PUCCH, the second TCI state is effective at a second time domain position and the third TCI state is not effective, where the second time domain position is a starting position of a second time unit, and the second time unit is first one time unit after a second time interval after a last symbol occupied by the second PUCCH; or
in the case where the first TCI information is used to determine the second TCI state and the third TCI state, if the time domain position of the second PUCCH is located after the time domain position of the third PUCCH, the third TCI state is effective at a third time domain position and the second TCI state is not effective, where the third time domain position is a starting position of a third time unit, and the third time unit is first one time unit after a third time interval after a last symbol of the third PUCCH.

In an implementation, the second time interval and the third time interval are associated with different spatial parameters, respectively.

In an implementation, in the case where the first TCI information is used to determine the second TCI state and the third TCI state, the second TCI state is effective at a fourth time domain position, and the third TCI state is effective at a fifth time domain position;
where the fourth time domain position is a starting position of a fourth time unit, and the fourth time unit is first one time unit after a fourth time interval after a last symbol occupied by the second PUCCH; the fifth time domain position is a starting position of a fifth time unit, and the fifth time unit is first one time unit after a fifth time interval after a last symbol occupied by the third PUCCH.

In an implementation, the fourth time interval and the fifth time interval are associated with different spatial parameters, respectively.

In an implementation, the time unit includes at least one of: a slot, a symbol, a frame, or a subframe.

In an implementation, the first channel is a physical downlink shared channel (PDSCH).

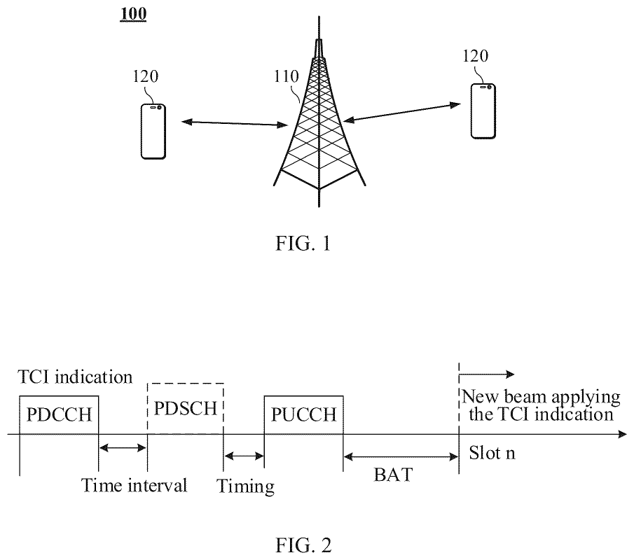

Exemplarily, the communication system 100 applied by the embodiments of the present application is shown in FIG. 1. The communication system 100 may include a network device 110, and the network device 110 may be a device that communicates with a terminal device 120 (also referred to as a communication terminal or a terminal). The network device 110 may provide communication coverage for a specific geographical area and may communicate with a terminal device located within the coverage area.

FIG. 1 exemplarily shows one network device and two terminal devices, and in some embodiments, the communication system 100 may include a plurality of network devices and may include another number of terminal devices within a coverage range of each network device, the embodiments of the present application are not limited thereto.

In some embodiments, the communication system 100 may also include other network entities such as a network controller and a mobility management entity, etc., which are not limited to the embodiments of the present application.

It should be understood that, in the embodiments of the present application, a device with a communication function in the network/system may be referred to as a communication device. Taking the communication system 100 shown in FIG. 1 as an example, the communication device may include the network device 110 and the terminal device 120 with the communication function, and the network device 110 and the terminal device 120 may be the specific devices described above, which will not be repeated herein; the communication device may also include other devices in the communication system 100, such as a network controller, a mobility management entity, and other network entities, which are not limited in the embodiments of the present application.

It should be understood that the terms herein “system” and “network” are often used interchangeably herein. The term herein “and/or” is only an association relationship to describe associated objects, meaning that there may be three kinds of relationships, for example, A and/or B may mean three cases where: A exists alone, both A and B exist, and B exists alone. In addition, a character “/” herein generally means that related objects before and after “/” are in an “or” relationship.

It should be understood that the present document relates to a first communication device and a second communication device, and the first communication device may be a terminal device, such as a mobile phone, a machine facility, a customer premise equipment (CPE), an industrial device, a vehicle, etc; the second communication device may be a counterpart communication device of the first communication device, such as a network device, a mobile phone, an industrial device, a vehicle, etc. The first communication device as a terminal device and the second communication device as a network device, are taken as a specific instance herein.

The terms used in the implementation parts of the present application are only used to explain specific embodiments of the present application and are not intended to limit the present application. The terms “first”, “second”, “third” and “fourth” etc., in the description, claims and drawings of the present application are used to distinguish different objects rather than to describe a specific order. In addition, the terms “including” and “having” and any derivations thereof are intended to cover non-exclusive inclusion.

It should be understood that the “indication” mentioned in the embodiments of the present application may be a direct indication, may also be an indirect indication, or may also represent having an association relationship. For example, A indicates B, which may mean that A directly indicates B, for example, B may be acquired by A; may also mean that A indirectly indicates B, for example, A indicates C, and B may be acquired by C; or may also mean that there is an association relationship between A and B.

In the description of the embodiments of the present application, the term “correspondence” may mean that there is a direct correspondence or indirect correspondence between the two, it may also mean that there is an associated relationship between the two, or it may also mean a relationship of indicating and being indicated or a relationship of configuring and being configured, etc.

In the embodiments of the present application, “predefined” or “preconfigured” may be implemented by pre-saving corresponding codes, tables or other manners that may be used to indicate related information, in the device (for example, including the terminal device and the network device), and the present application does not limit its specific implementation. For example, the predefined may refer to what is defined in a protocol.

In the embodiments of the present application, the “protocol” may refer to standard protocols in the communication field, for example, which may be an evolution of the existing LTE protocol, NR protocol, Wi-Fi protocol, or other communication system-related protocols related thereto. The present application does not limit the protocol type.

In order to facilitate the understanding of technical solutions of the embodiments of the present application, the technical solutions of the present application are described in detail below through specific embodiments. The following related technologies, as optional solutions, may be randomly combined with the technical solutions of the embodiments of the present application, which all belong to the protection scope of the embodiments of the present application. The embodiments of the present application include at least some of the following contents.

In the standardization progress of the 3rd Generation Partnership Project (3GPP), the concept of a Transmission Configuration Indicator (TCI) state has been proposed in the 15th Release (Release 15 or Rel-15), which is used for the downlink spatial domain QCL (beam) indication, and the delivery of QCL information of time domain and frequency domain. Specifically, the Quasi-co-located (QCL) relationship may be simply described as a relationship of large-scale fading from a certain source reference signal pointing to a target reference signal. For the beam indication, after the terminal device obtains the QCL relationship between the two source and target reference signals from the network, it may use a receiving beam that was previously used to receive the source reference signal, when receiving the target reference signal. A specific introduction is as follows.

A configuration and indication of a TCI state includes three steps: Radio Resource Control (RRC) configuration, media access control layer control element (Media Access Control Control Element, MAC CE) activation, and Downlink Control Information (DCI) indication, and specific processes of them are as follows.

The RRC configures at most M TCI states for the terminal by PDSCH Configuration (PDSCH-Config), where a value of M is determined by a terminal capability.

The MAC CE activates at most 8 TCI state groups for mapping to a 3-bit TCI information field in the DCI. Herein, each TCI state group activated by the MAC CE may include 1 or 2 TCI states. If a higher layer parameter configuration DCI includes a TCI indication field, a DCI format 1_1 may indicate one TCI state group from the TCI state groups activated by the MAC. If the higher layer parameter configuration DCI does not include the TCI indication field or data is scheduled via DCI format 1_0, the DCI will not include a TCI state indication field.

Herein, one TCI state may include the following configuration:
a TCI state ID, for identifying one TCI state;
QCL information 1; and
QCL Information 2.

Herein, one QCL information may further include the following information:
a QCL type configuration, which may be one of QCL type A, QCL type B, QCL type C, or QCL type D; and
a QCL reference signal configuration, which includes a cell identity (ID) in which the reference signal is located, a bandwidth part (Band Width Part, BWP) ID, and reference signal information (which may be a Channel State Information Reference Signal (CSI-RS) resource ID or a Synchronization Signal Block (SSB) index).

Herein, definitions of different QCL type configurations are as follows:
‘QCL-TypeA’: {Doppler shift, Doppler spread, average delay, delay spread};
‘QCL-TypeB’: {Doppler shift, Doppler spread};
‘QCL-TypeC’: {Doppler shift, average delay}; and
‘QCL-TypeD’: {Spatial Rx parameter}.

The indication mechanism of the aforementioned TCI state is only used for downlink channels and signals, and has many limitations when applied in the NR system. In order to provide a more unified uplink and downlink beam management mechanism to the NR system, on the basis of the design of TCI states by referring to the 15th release (Release15, Rel-15) or the 16th release (Release 16, Rel-16), a concept of a unified TCI state is proposed in 17th release (Release17, Rel-17), and it adds important new functions as follows exemplarily:

Three modes of the unified TCI state are designed, that is, a joint TCI state applicable to uplink and downlink channels and signals; a downlink TCI state only applicable to downlink channels and signals; and an uplink TCI state only applicable to uplink channels and signals.

The downlink channel (partial Physical Downlink Control Channel (PDCCH), Physical Downlink Shared Channel (PDSCH)) and signal (aperiodic Channel State Information Reference Signal (CSI-RS)) use the same downlink transmission indication beam, and use the downlink TCI state or the joint TCI state.

The uplink channel (partial Physical Uplink Control Channel (PUCCH), Physical Uplink Shared Channel (PUSCH)) and signal (Sounding Reference Signal (SRS)) use the same uplink transmission beam, and use the uplink TCI state or the joint TCI state.

The unified TCI state may be dynamically updated and indicated by using the MAC CE and/or DCI.

Applicable to a scenario of Carrier Aggregation (CA), a beam indication on a single carrier unit (Component carrier, CC) may be applicable to multiple different CCs.

An inter-cell beam management function is supported.

A first indication method of the unified TCI state in Rel-17 may be configured by the RRC and activated by the MAC CE, or a second indication method may be configured by the RRC and activated by the MAC CE, and dynamically indicated by the DCI. In a case where the DCI dynamically indicates the unified TCI state, a new beam corresponding to a TCI state indicated in this DCI may be effective after a beam application time. For a new beam corresponding to a TCI state activated by the MAC CE, an effective time of the MAC CE is complied with.

Beam Application Time (BAT): in Rel-17, BAT is shown as FIG. 2, the unified TCI state is indicated by downlink DCI, and this downlink DCI may have a corresponding scheduled PDSCH, or may not have the corresponding scheduled PDSCH. A time starting point of the BAT is a last symbol of a PUCCH carrying a corresponding hybrid automatic repeat request (Hybrid Automatic Repeat reQuest, HARQ) feedback. Assuming that the BAT is Y symbols, the time from the last symbol of the PUCCH to a first symbol of a slot n is greater than or equal to Y symbols. Therefore, channels and signals transmitted in the slot n and later slots adopt the new beam, and channels and signals transmitted before the slot n adopt the old beam. Herein, the old beam is a beam before the beam application time or a beam before the beam updating.

For a better understanding of the embodiments of the present application, the beam determination of channels in Rel-15/Rel-16/Rel-17 related to the present application is illustrated.

The uplink channel or signal: for the PUSCH or PUCCH, if the UE receives a TCI state indicated by the DCI or MAC CE, a beam corresponding to this TCI state is adopted in a first slot after the BAT; and the old beam is adopted before the first slot after the BAT. For the SRS, whether to apply the unified TCI mechanism specified in Rel-17 may be configured by an RRC signaling. If it is configured as “YES”, the timeline of the BAT is complied with as well; and if it is configured as “NO”, the mechanism of Rel-17 is not applied.

The downlink channel or signal: for the PDSCH, if the UE receives a TCI state indicated by the DCI or MAC CE, a beam corresponding to this TCI state is adopted in a first slot after the BAT; and the old beam is adopted before the first slot after the BAT. For the aperiodic CSI-RS, whether to apply the unified TCI mechanism specified in Rel-17 may be configured by an RRC signaling. If it is configured as “YES”, the timeline of the BAT is complied with as well; and if it is configured as “NO”, the mechanism of Rel-17 is not applied. For the periodic CSI-RS and semi-persistent CSI-RS, the unified TCI mechanism specified in Rel-17 is not applied.

To facilitate a better understanding of the embodiments of the present application, the PUSCH transmission and PUCCH transmission of the multi-transmission reception point (TRP) of Rel-17 related to the present application is illustrated.

In NR Rel-17, the uplink multi-TRP PUSCH transmission scheme scheduled by single DCI is discussed, but in NR Rel-17, only the scheme of PUSCH time-division multiplexing (TDM) repetition transmission (repetition) is discussed. If the RRC configures two SRS resource sets, the UE may transmit the PUSCH to two TRPs by means of the TDM repetition. The TDM repetition is performed on the PUSCH repetition transmitted to the two TRPs by the UE, in accordance with cyclic mapping or sequential mapping.

For the multi-TRP PUCCH transmission discussed in NR Rel-17, each PUCCH resource may be configured to be associated with one spatial relationship or two spatial relationships. If it is configured to be associated with two spatial relationships, the TDM repetition is performed in accordance with the cyclic mapping or sequential mapping.

To facilitate a better understanding of the embodiments of the present application, problems solved by the present application are illustrated.

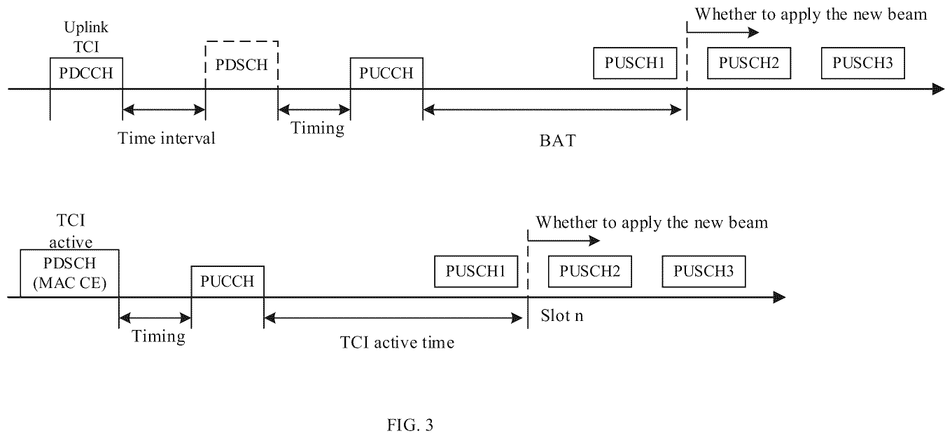

In NR Rel-17, the unified TCI mechanism is only applied to the single TRP system, and does not involve scenarios of the PUSCH repetition, PUCCH repetition, or PDSCH repetition. As shown in FIG. 3, taking the PUSCH repetition as an example, if during the PUSCH repetition, a new beam (a new TCI) takes effect, in this scenario, the terminal side and the network side may have different cognition of beams.

For the 18^{th} release (Release18, Rel-18), the unified TCI mechanism will be extended to be applied to a scenario of multiple TRPs/antenna panels, in this scenario, there are the following possible cases.

The downlink DCI/MAC CE indicates 2 joint TCI states, or 2 uplink TCI states and/or 2 downlink TCI states. The UE transmits an uplink channel or signal by the 2 TCI states, or the UE receives a downlink channel or signal by the 2 TCI states.

The downlink DCI/MAC CE indicates 2 joint TCI states, or 2 uplink TCI states and/or 2 downlink TCI states. The UE transmits an uplink channel or signal by 1 TCI state, or the UE receives a downlink channel or signal by 1 TCI state.

The downlink DCI indicates 1 joint TCI state, or 1 uplink TCI state and/or 1 downlink TCI state. The UE transmits an uplink channel or signal by 2 TCI states, or the UE receives a downlink channel or signal by 2 TCI states.

The downlink DCI indicates 1 joint TCI state, or 1 uplink TCI state and/or 1 downlink TCI state. The UE transmits an uplink channel or signal by 1 TCI state, or the UE receives a downlink channel or signal by 1 TCI state.

In these scenarios, during multiple transmissions of the uplink or downlink channel, if the new beam takes effect, how should the UE behavior be defined.

Based on the above technical problems, the present application provides a scheme for repetition transmissions of a channel or signal, in which whether a new TCI state is effective is determined during the repetition of the channel or signal, or an effective time of a new TCI state is determined after the repetition of the channel or signal, thereby ensuring consistency in beam understanding of the terminal and the network.

The technical solutions of the present application are described in detail below by specific embodiments.

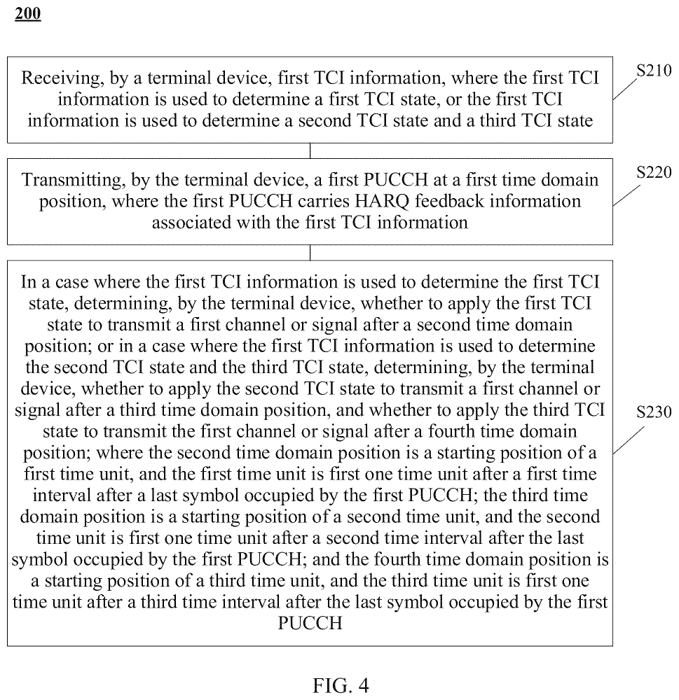

FIG. 4 is a schematic flow chart of a method 200 for wireless communication according to the embodiments of the present application. As shown in FIG. 4, the method 200 for wireless communication may include at least a part of the following contents:
S210, receiving, by a terminal device, first TCI information, where the first TCI information is used to determine a first TCI state, or the first TCI information is used to determine a second TCI state and a third TCI state;
S220, transmitting, by the terminal device, a first PUCCH at a first time domain position, where the first PUCCH carries HARQ feedback information associated with the first TCI information; and
S230, in a case where the first TCI information is used to determine the first TCI state, determining, by the terminal device, whether to apply the first TCI state to transmit a first channel or signal after a second time domain position; or in a case where the first TCI information is used to determine the second TCI state and the third TCI state, determining, by the terminal device, whether to apply the second TCI state to transmit a first channel or signal after a third time domain position, and whether to apply the third TCI state to transmit the first channel or signal after a fourth time domain position; where the second time domain position is a starting position of a first time unit, and the first time unit is first one time unit after a first time interval after a last symbol occupied by the first PUCCH; the third time domain position is a starting position of a second time unit, and the second time unit is first one time unit after a second time interval after the last symbol occupied by the first PUCCH; and the fourth time domain position is a starting position of a third time unit, and the third time unit is first one time unit after a third time interval after the last symbol occupied by the first PUCCH.

In the embodiments of the present application, the first TCI information is used to determine the first TCI state, which may also be described as that: the first TCI information is used to indicate the first TCI state. Similarly, the first TCI information is used to determine the second TCI state and the third TCI state, which may also be described as that: the first TCI information is used to indicate the second TCI state and the third TCI state.

In the embodiments of the present application, the “first channel or signal” may be understood as: a first channel or a first signal, that is, the first channel or signal may be a channel or a signal.

In some embodiments, the TCI state described in the embodiments of the present application is the unified TCI state.

In the embodiments of the present application, the time unit includes but is not limited to one of: a slot, a symbol, a frame, or a subframe. Specifically, the time unit may be applicable to a part of or all the time units involved in the present application (such as the/a first time unit, the/a second time unit, the/a third time unit, first one time unit, or second one time unit, etc.), which are not limited in the present application.

In the embodiments of the present application, for a scenario of a single carrier, the time interval may adopt a Subcarrier spacing (SCS) configured by a carrier, or the time interval may adopt a subcarrier spacing configured by an activated Bandwidth Part (BWP), or the time interval may adopt a subcarrier spacing configured by an initial BWP. For a scenario of multiple carriers, the time interval may adopt a minimum SCS configured in the multiple carriers, or the time interval may adopt a minimum SCS configured in an activated BWP of the multiple carriers, or the time interval may adopt a minimum SCS configured in an initial BWP of the multiple carriers, or the time interval may adopt a minimum SCS configured in an initial BWP and an activated BWP of the multiple carriers. Specifically, the time interval may be applicable to a part of or all the time intervals involved in the present application (such as the/a first time interval, the/a second time interval, or the/a third time interval), which are not limited in the present application.

In some embodiments, the first TCI information is carried by the DCI. For example, the first TCI information is an information domain (such as a TCI domain) of the DCI. For example, the HARQ feedback information associated with the first TCI information may be HARQ feedback information corresponding to a channel or signal scheduled by a PDCCH, where the first TCI information is carried by DCI in the PDCCH. Specifically, for example, N TCI states may be configured via RRC, where N is a positive integer; and multiple TCI states (joint TCI states, or uplink TCI states, or downlink TCI states) among the N TCI states may be activated via MAC CE, multiple pairs of uplink and downlink TCI states (for each pair, one uplink and one downlink TCI state) among the N TCI states may be activated via MAC CE, or multiple pairs of uplink TCI states among the N TCI states may be activated via MAC CE, or multiple pairs of downlink TCI states among the N TCI states may be activated via MAC CE, or multiple pairs of joint TCI states among the N TCI states may be activated via MAC CE; further, a specific TCI state may be indicated or determined from the activated TCI states via DCI.

In some embodiments, the first TCI information is carried via MAC CE. For example, the first TCI information is an information domain or field in the MAC CE. For example, the HARQ feedback information associated with the first TCI information may be HARQ feedback information corresponding to a PDSCH, where the first TCI information is carried via MAC CE in the PDSCH. Specifically, for example, N TCI states may be configured via RRC, where N is a positive integer; and a TCI state (a joint TCI state, an uplink TCI state, or a downlink TCI state) among the N TCI states may be activated via MAC CE, or a pair of uplink and downlink TCI states among the N TCI states may be activated via MAC CE, or a pair of uplink TCI states among the N TCI states may be activated via MAC CE, or a pair of downlink TCI states among the N TCI states may be activated via MAC CE, or a pair of joint TCI states among the N TCI states may be activated via MAC CE.

In some embodiments, in a case where the first TCI information is carried by the DCI, the first time interval is Y₁ time units; or, in a case where the first TCI information is carried by the MAC CE, the first time interval is an effective time of the MAC CE.

Specifically, a duration of the effective time of the MAC CE is k+3·Nₛₗₒₜ^{subframe,μ}, where k is a slot in which the PUCCH is located, and μ is a subcarrier spacing configured by the slot of the PUCCH.

In some embodiments, the second time interval is Y₂ time units, and/or the third time interval is Y₃ time units.

Herein, Y₁, Y₂ and Y₃ are all positive integers.

In some embodiments, Y₁ is agreed by a protocol, or Y₁ is configured by a network device according to a minimum beam application time supported by the terminal device; or Y₂ and Y₃ are agreed by a protocol, or Y₂ and Y₃ are configured by the network device according to a minimum beam application time supported by the terminal device. Optionally, values of Y₂ and Y₃ may be different.

Specifically, corresponding to different spatial parameters, the minimum beam application supported by the terminal device may be different, that is, the values of Y₂ and Y₃ may be different.

In some embodiment, the first channel or signal includes at least one of: PUSCH, PUCCH, SRS, PDSCH, PDCCH, aperiodic CSI-RS, or Demodulation Reference Signal (DMRS). Herein, the PUSCH may be a dynamically scheduled PUSCH or a configured PUSCH. That is, the first channel or signal may be an uplink channel or signal, for example, PUSCH, PUCCH, SRS; or the first channel or signal may be a downlink channel or signal, for example, PDSCH, PDCCH, aperiodic CSI-RS, DMRS, etc.

In some embodiments, the first channel or signal is transmitted m times, that is, the number of transmissions of the first channel or signal in time domain is m, and m is a positive integer. For example, the first channel or signal is a PUSCH, the terminal device transmits m repetition transmissions of the PUSCH in time domain, which may be a PUSCH repetition type A (a starting symbol position and an ending symbol position of each PUSCH repetition are the same in time domain), or a PUSCH repetition type B (a slot may be used to transmit multiple PUSCH repetitions); or the terminal device transmits m PUSCHs in time domain, and each PUSCH corresponds to a different transmission layer. For another example, the first channel or signal is a PUCCH, and the terminal device transmits m repetition transmissions of the PUCCH in time domain. For another example, the first channel or signal is an SRS, the terminal device transmits m SRSs in time domain, the m SRSs may be located in one or more slots. For yet another example, the first channel or signal is a PDSCH, the terminal device receives m repeated PDSCHs in time domain, or the terminal device receives m PDSCHs corresponding to different transmission layers in time domain.

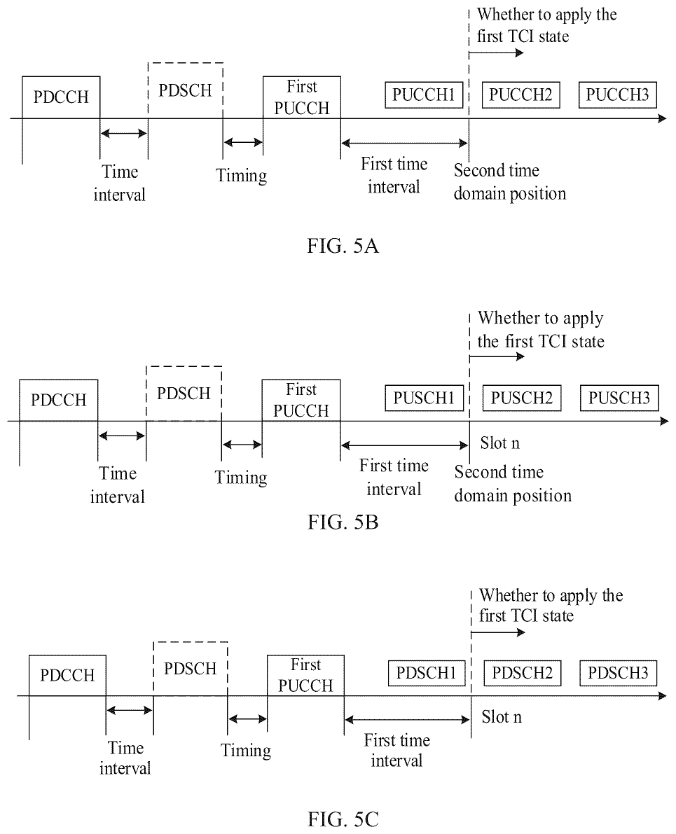

Specifically, for example, as shown in FIGS. 5A to 5C, the first TCI information is carried by DCI in a PDCCH, and the first TCI information is used to determine the first TCI state. As shown in FIG. 5 A, the first channel or signal is a PUCCH, and the PUCCH is transmitted at least 3 times in time domain, a starting position of a PUCCH1 is located before the second time domain position, and starting positions of a PUCCH 2 and PUCCH 3 are located after the second time domain position, the terminal device may determine whether to apply the first TCI state to transmit the PUCCH after the second time domain position, or the terminal device may determine whether to apply a beam corresponding to the first TCI state to transmit the PUCCH after the second time domain position. As shown in FIG. 5B, the first channel or signal is a PUSCH, and the PUSCH is transmitted at least 3 times in time domain, a starting position of a PUSCH1 is located before the second time domain position, and starting positions of a PUSCH2 and PUSCH3 are located after the second time domain position, the terminal device may determine whether to apply the first TCI state to transmit the PUSCH after the second time domain position, or the terminal device may determine whether to apply a beam corresponding to the first TCI state to transmit the PUSCH after the second time domain position. As shown in FIG. 5C, the first channel or signal is a PDSCH, and the PDSCH is transmitted at least 3 times in time domain, a starting position of a PDSCH1 is located before the second time domain position, and starting positions of a PDSCH2 and PUSCH3 are located after the second time domain position, the terminal device may determine whether to apply the first TCI state to transmit the PDSCH after the second time domain position, or the terminal device may determine whether to apply a beam corresponding to the first TCI state to transmit PDSCH after the second time domain position.

In some embodiments, in the case where the first TCI information is used to determine the first TCI state, the first TCI state is a joint TCI state, or the first TCI state is an uplink TCI state, or the first TCI state is a downlink TCI state. Optionally, in a case where the first TCI state is the uplink TCI state, the first TCI information is further used to determine a downlink TCI state; or in a case where the first TCI state is the downlink TCI state, the first TCI information is further used to determine an uplink TCI state.

That is, in a case where the first TCI information is used to determine a TCI state, the first TCI information may be used to determine one of:
a joint TCI state, where the joint TCI state is applied to an uplink channel or a downlink channel;
an uplink TCI state, where the uplink TCI state is applied to an uplink channel;
a downlink TCI state, where the downlink TCI state is applied to a downlink channel; or
an uplink TCI state and a downlink TCI state, where the uplink TCI state is applied to an uplink channel and the downlink TCI state is applied to a downlink channel.

In some embodiments, the first TCI information may be used to determine a first type of TCI, and the first type of TCI may include at least one of:
a joint TCI state, where the joint TCI state is applied to an uplink channel or a downlink channel;
an uplink TCI state, where the uplink TCI state is applied to an uplink channel;
a downlink TCI state, where the downlink TCI state is applied to a downlink channel; or
an uplink TCI state and a downlink TCI state, where the uplink TCI state is applied to an uplink channel and the downlink TCI state is applied to a downlink channel.

In some embodiments, in the case where the first TCI information is used to determine the second TCI state and the third TCI state, the second time interval is associated with a first spatial parameter, and the third time interval is associated with a second spatial parameter. That is, in the embodiments of the present application, the second time interval and third time interval may be associated with different spatial parameters.

In some embodiments, the spatial parameter may include but be not limited to at least one of: TCI state information, antenna panel information or TRP information, control resource set (CORESET) group information, reference signal set information, capability set information, or beam information.

In some embodiments, the antenna panel information may include an antenna panel identity (ID) or index.

In some embodiments, the TRP information may include a TRP ID or index.

In some embodiments, the CORESET group information may include a CORESET group ID or index.

In some embodiments, reference signal set information may be Synchronization Signal Block (SSB) resource set information, Channel State Information Reference Signal (CSI-RS) resource set information, or SRS resource set information.

For example, reference signal set information may include an index of a reference signal set, for example an index of an SSB set, an index of a CSI-RS resource set, or an index of an SRS resource set.

In some embodiments, reference signal information may include SSB resource information, CSI-RS resource information or SRS resource information. For example, reference signal information may be an index of an SRS resource, an SSB resource, or a CSI-RS resource.

In some embodiments, the beam information may include a beam identity (ID) or index.

In the embodiments of the present application, a beam may also be called a spatial domain transmission filter or spatial domain filter for transmission, or a spatial domain reception filter or spatial domain filter for reception, or a spatial reception parameter (spatial Rx parameter).

In some embodiments, the capability set information may include one or more parameters. For example, the capability set information may be a capability set supported by the terminal device or reference signal information associated with a capability set supported by the terminal device.

In some embodiments, the capability set information includes but is not limited to at least one of:
a maximum number of SRS ports, a maximum number of uplink transmission layers, a codebook subset type, an uplink full-power transmission mode, an SRS antenna switching capability, an SRS carrier switching capability, a number of SRS resources transmitted simultaneously, a maximum modulation method for an uplink data transmission, a maximum modulation method for an downlink data transmission, a number of hybrid automatic repeat request (HARQ) processes supported by the terminal device, a channel bandwidth supported by the terminal device, a number of transmission antennas supported by the terminal device, a PDSCH processing capability, a PUSCH processing capability, power saving capability of the terminal device, coverage enhancement capability of the terminal device, an improvement capability of data transmission rate of the terminal device, a short latency processing capability of the terminal device, a small data transmission capability of the terminal device, a non-active data transmission capability of the terminal device, a transmission reliability capability of the terminal device, or an ultra-reliable and low latency communication (URLLC) data transmission capability of the terminal device.

In some embodiments, the second TCI state and the third TCI state are two uplink TCI states, and the second TCI state and the third TCI state are respectively applied to different transmission layers of an uplink channel, or the second TCI state and the third TCI state are respectively applied to different repetition transmissions of an uplink channel. In some embodiments, the second TCI state and the third TCI state are two downlink TCI states, and the second TCI state and the third TCI state are respectively applied to different transmission layers of a downlink channel, or the second TCI state and the third TCI state are respectively applied to different repetition transmissions of a downlink channel. In some embodiments, the second TCI state and the third TCI state are two joint TCI states, and the second TCI state and the third TCI state are respectively applied to different transmission layers of an uplink channel and/or a downlink channel, or the second TCI state and the third TCI state are respectively applied to different repetition transmissions of an uplink channel and/or a downlink channel.

In some embodiments, the first TCI information may be used to determine a second type of TCI, where the second type of TC may include at least one of:
two joint TCI states, where each joint TCI state is applied to an uplink channel and a downlink channel;
two uplink TCI states, where the two uplink TCI states are respectively applied to different transmission layers of an uplink channel, or respectively applied to different repetition transmissions of an uplink channel; or
two downlink TCI states, where the two downlink TCI states are respectively applied to different transmission layers of a downlink channel, or respectively applied to different repetition transmissions of a downlink channel.

In some embodiments, the terminal device may determine an association relationship of the first channel or signal and TCI information according to the first TCI information, where the first TCI information is carried by DCI, MAC CE, or RRC signaling.

In some embodiments, the terminal device may directly determine the association relationship of the first channel or signal and TCI information according to the content of the first TCI information. For example, if the first TCI information is used to determine the first type of TCI, the first channel is associated with one TCI state, and the first TCI information is used to update the one TCI state; if the first TCI information is used to determine the second type of TCI, the first channel is associated with two TCI states, and the first TCI information is used to update the two TCI states.

In some embodiments, in the case where the first TCI information is used to determine the second TCI state and the third TCI state, the terminal device is capable of adopting two TCI states to transmit m transmissions of the first channel or signal. For example, when m equals 2, a first transmission and a second transmission of the first channel or signal apply different TCI states. For example, when m is greater than 2, m transmissions of the first channel or signal are associated with two TCI states by means of cyclic mapping or sequential mapping, according to the configuration of a higher layer. Specifically, each transmission of the m transmissions of the first channel or signal may be understood as a different repetition transmission of the first channel or signal.

Technical solutions of the present application are described in detail below through Embodiment 1 and Embodiment 2.

Embodiment 1, the first TCI information is used to determine the first TCI state, that is, in the aforementioned S230, the terminal device determines whether to apply the first TCI state to transmit the first channel or signal after the second time domain position. Specifically, Embodiment 1 may correspond to a single TRP and the number of transmissions of the first channel or signal is m.

In some implementations of Embodiment 1, if a starting position of a first transmission of m transmissions of the first channel or signal is located before the second time domain position, the terminal device determines that second TCI information is applied to all the m transmissions of the first channel or signal, where the second TCI information is TCI information applied by the terminal device before the second time domain position (assuming that it is Scheme 1 of Embodiment 1). That is, the terminal device does not expect that the TCI state is switched during the m transmissions. Specifically, the m transmissions adopt a same TCI state, that is, adopt a same beam to transmit the m transmissions, thereby maintaining consistency of the beam, and a time interval between two adjacent transmissions may be not enough to switch the beam, which avoids a switching delay caused by switching the beam.

In some implementations of Embodiment 1, if starting positions of first mi transmissions of m transmissions of the first channel or signal are located before the second time domain position, and starting positions of last m-mi transmissions of the m transmissions of the first channel or signal is located after the second time domain position, the terminal device determines to apply the first TCI state to transmit the first channel or signal after the second time domain position; where the first mi transmissions of the m transmissions of the first channel or signal apply second TCI information, and the last m-mi transmissions of the m transmissions of the first channel or signal apply the first TCI state, the second TCI information is TCI information applied by the terminal device before the second time domain position, and m and mi are both positive integers (assuming that it is Scheme 2 of Embodiment 1). Optionally, a time interval between an mi-th transmission and an (m₁+1)-th transmission of the first channel or signal is greater than a beam switching time. Because the unified TCI state mechanism is adopted, after the second time domain position, the first TCI information will update beams of all corresponding channels, and the first channel also adopts the first TCI information, which may maintain beam consistency of the system, and may avoid a collision with beams of other channels after the second time domain position.

In some embodiments, a time unit of the beam switching time may be a symbol, a slot, or an absolute time, etc. Specifically, for a single carrier scenario, the beam switching time may adopt an SCS configured by a carrier, or the beam switching time may adopt a subcarrier spacing configured by an activated BWP, or the beam switching time may adopt a subcarrier spacing configured by an initial BWP. For a multi-carrier scenario, the beam switching time may adopt a minimum SCS configured in multiple carriers; or the beam switching time may adopt a minimum SCS configured in an activated BWP of the multiple carriers; or the beam switching time may adopt a minimum SCS configured in an initial BWP of the multiple carriers; or the beam switching time may adopt a minimum SCS configured in an initial BWP and an activated BWP of the multiple carriers.

In some implementations of Embodiment 1, if starting positions of first mi transmissions of m transmissions of the first channel or signal are located before the second time domain position, and starting positions of last m-mi transmissions of the m transmissions of the first channel or signal are located after the second time domain position, the terminal device determines to discard the last m-mi transmissions of the first channel or signal located after the second time domain position; where the first mi transmissions of the m transmissions of the first channel or signal apply second TCI information, the second TCI information is TCI information applied by the terminal device before the second time domain position, and m and mi are both positive integers (assuming that it is Scheme 3 of Embodiment 1). Therefore, the beam collision may be avoided, and a problem of not being able to switch due to not meeting the beam switching time may be avoided as well.

It should be noted that, in the embodiments of the present application, the “discard” may be replaced with “not transmit”.

In some implementations of Embodiment 1, if starting positions of first mi transmissions of m transmissions of the first channel or signal are located before the second time domain position, and starting positions of last m-mi transmissions of the m transmissions of the first channel or signal are located after the second time domain position, the terminal device determines to delay an application time of the first TCI state to an end of the last m-mi transmissions of the first channel or signal, or the terminal device determines to delay an application time of the first TCI state to a first time unit after an end of transmissions of the first channel or signal; where the first mi transmissions of the m transmissions of the first channel or signal apply second TCI information, the second TCI information is TCI information applied by the terminal device before the second time domain position, and m and mi are both positive integers (assuming that it is Scheme 4 of Embodiment 1). Therefore, the beam collision may be avoided.

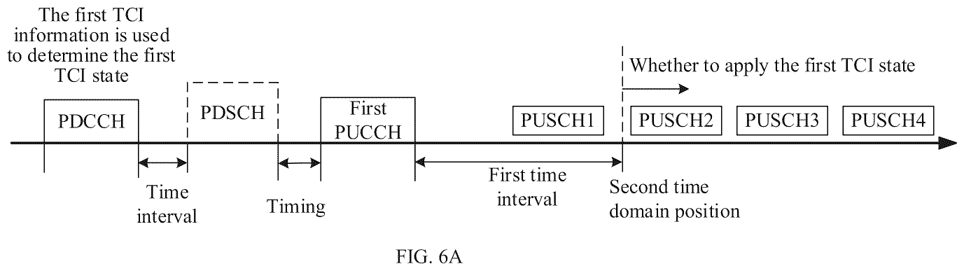

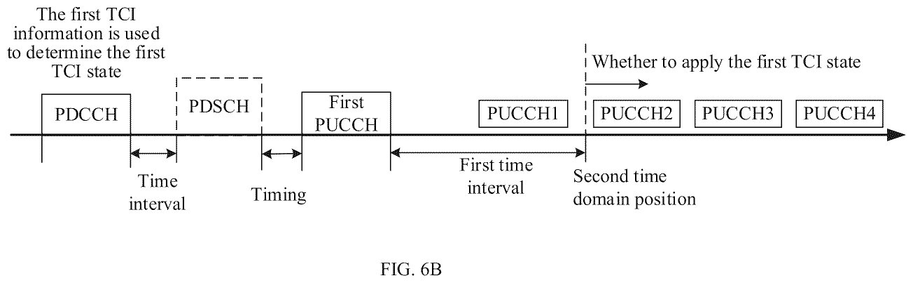

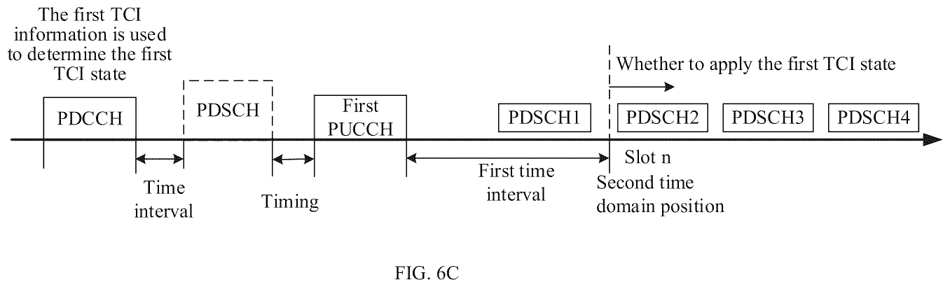

Specifically, for example, as shown in FIGS. 6A to 6C, the first TCI information is carried by DCI in a PDCCH, and the first TCI information is used to determine the first TCI state. As shown in FIG. 6A, the first channel or signal is a PUSCH, and the PUSCH is transmitted at least 4 times in time domain, a starting position of a PUSCH1 is located before the second time domain position, starting positions of a PUSCH 2, PUSCH 3, and PUSCH 4 are located after the second time domain position, the terminal device may, based on the schemes of Embodiment 1 mentioned above, determine whether to apply the first TCI state to transmit the PUSCH after the second time domain position, or the terminal device may, based on the schemes of Embodiment 1 mentioned above, determine whether to apply a beam corresponding to the first TCI state to transmit PUSCH after the second time domain position. As shown in FIG. 6B, the first channel or signal is a PUCCH, and the PUCCH is transmitted at least 4 times in time domain, a starting position of a PUCCH1 is located before the second time domain position, starting positions of a PUCCH 2, PUCCH 3, and PUCCH 4 are located after the second time domain position, the terminal device may, based on the schemes of Embodiment 1 mentioned above, determine whether to apply the first TCI state to transmit the PUCCH after the second time domain position, or the terminal device may, based on the schemes of Embodiment 1 mentioned above, determine whether to apply a beam corresponding to the first TCI state to transmit PUCCH after the second time domain position. As shown in FIG. 6C, the first channel or signal is a PDSCH, and the PDSCH is transmitted at least 4 times in time domain, a starting position of a PDSCH1 is located before the second time domain position, starting positions of a PDSCH2, PDSCH 3, and PDSCH 4 are located after the second time domain position, the terminal device may, based on the schemes of Embodiment 1 mentioned above, determine whether to apply the first TCI state to transmit the PDSCH after the second time domain position, or the terminal device may, based on the schemes of Embodiment 1 mentioned above, determine whether to apply a beam corresponding to the first TCI state to transmit PDSCH after the second time domain position.

Specifically, in Embodiment 1, which scheme the terminal device determining to use is determined based on one or more of Scheme 1 to Scheme 4 of Embodiment 1 configured by the network device, or agreed by a protocol, or determined according to a capability of the terminal device, or determined by the capability of the terminal device and one or more of Scheme 1 to Scheme 4 of Embodiment 1 configured by the network device. In other words, the network device may configure to use a certain scheme of Scheme 1 to Scheme 4 of Embodiment 1; or the network device may configure to use a certain scheme of Scheme 1 to Scheme 4 of Embodiment 1 based on the capability of the terminal device; or the network device may agree to use a certain scheme of Scheme 1 to Scheme 4 of Embodiment 1 based on a protocol.

Embodiment 2, the first TCI information is used to determine the second TCI state and the third TCI state, that is, in the aforementioned S230, the terminal device determines whether to apply the second TCI state to transmit the first channel or signal after the third time domain position, and whether to apply the third TCI state to transmit the first channel or signal after the fourth time domain position. Specifically, Embodiment 2 may correspond to multiple TRPs, the second time interval is associated with a first spatial parameter, the third time interval is associated with a second spatial parameter, and the number of transmissions of the first channel or signal is m.

In some implementations of Embodiment 2, if a starting position of a first transmission of m transmissions of the first channel or signal is earlier than an earlier time domain position in the third time domain position and the fourth time domain position in time domain, the terminal device determines that the m transmissions of the first channel or signal all apply second TCI information; where the second TCI information is TCI information applied by the terminal device before the earlier time domain position in the third time domain position and the fourth time domain position in time domain, and m is a positive integer (assuming that it is Scheme 1 of Embodiment 2). Specifically, transmissions associated with different spatial parameters are not distinguished, and a unified mechanism is used to determine the TCI of m transmissions, which is easier to implement.

In some implementations of Embodiment 2, if a first transmission associated with the first spatial parameter in m transmissions of the first channel or signal is before the third time domain position, the terminal device determines that the m transmissions of the first channel or signal all apply second TCI information; or if a first transmission associated with the second spatial parameter in m transmissions of the first channel or signal is before the fourth time domain position, the terminal device determines that the m transmissions of the first channel or signal all apply second TCI information; where the second TCI information is TCI information applied by the terminal device before an earlier time domain position in the third time domain position and the fourth time domain position in time domain, and m is a positive integer (assuming that it is Scheme 2 of Embodiment 2). Specifically, the m transmissions adopt a same TCI state, that is, adopt a same beam to transmit the m transmissions, thereby maintaining consistency of the beam, and a time interval between two adjacent transmissions may be not enough to switch the beam, thereby avoiding a switching delay caused by switching the beam.

That is, For transmissions associated with the first spatial parameter and the second spatial parameter in the m transmissions of the first channel of signal, TCI states are determined respectively. Specifically, if the first transmission associated with the first spatial parameter in the m transmissions of the first channel or signal is before the third time domain position, all transmissions in the m transmissions associated with the first spatial parameter apply the second TCI information, that is, the first spatial parameter is not updated. If the first transmission associated with the second spatial parameter in the m transmissions of the first channel or signal is before the fourth time domain position, all transmissions in the m transmissions associated with the second spatial parameter apply the second TCI information, that is, the second spatial parameter is not updated.

In some implementations of Embodiment 2, the terminal device determines that a transmission located after the third time domain position and associated with the first spatial parameter in m transmissions of the first channel or signal applies the second TCI state, and that a transmission located after the fourth time domain position and associated with the second spatial parameter in the m transmissions of the first channel or signal applies the third TCI state (assuming that it is Scheme 3 of Embodiment 2). Optionally, a time interval between two adjacent transmissions associated with a same spatial parameter is greater than a beam switching time. Because the unified TCI state mechanism is adopted, after time domain positions corresponding to different spatial parameters, the first TCI information will update beams of all corresponding channels, the first channel or signal also adopts the first TCI information, which may maintain beam consistency of the system, and may avoid a collision with beams of other channels.

In some implementations of Embodiment 2, the terminal device determines to discard a transmission located after the third time domain position and associated with the first spatial parameter in m transmissions of the first channel or signal, and to discard a transmission located after the fourth time domain position and associated with the second spatial parameter in the m transmissions of the first channel or signal (assuming that it is Scheme 4 of Embodiment 2). Therefore, the beam collision may be avoided, and a problem of not being able to switch due to not meeting the beam switching time may be avoided as well.

In some implementations of Embodiment 2, the terminal device determines to delay an application time of the second TCI state and an application time of the third TCI state to an end of m transmissions of the first channel or signal (assuming that it is Scheme 5 of Embodiment 2).

In some implementations of Embodiment 2, the terminal device determines to delay an application time of the second TCI state to an end of a transmission associated with the first spatial parameter in m transmissions of the first channel or signal, or the terminal device determines to delay an application time of the second TCI state to a first time unit after an end of a transmission associated with the first spatial parameter in the m transmissions of the first channel or signal; and the terminal device determines to delay an application time of the third TCI state to an end of a transmission associated with the second spatial parameter in the m transmissions of the first channel or signal, or the terminal device determines to delay an application time of the third TCI state to a first time unit after an end of a transmission associated with the second spatial parameter in the m transmissions of the first channel or signal (assuming that it is Scheme 6 of Embodiment 2).

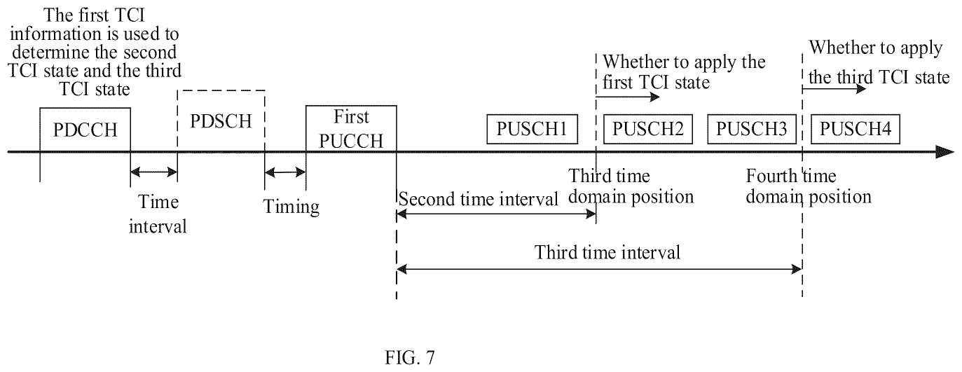

Specifically, for example, as shown in FIG. 7, the first TCI information is carried by DCI in a PDCCH, and the first TCI information is used to determine the second TCI state and the third TCI state, the second time interval is associated with the first spatial parameter, and the third time interval is associated with the second spatial parameter. As shown in FIG. 7, the first channel or signal is a PUSCH, and the PUSCH is transmitted at least 4 times in time domain, a starting position of a PUSCH1 is located before the third time domain position, starting positions of a PUSCH2 and PUSCH3 are located after the third time domain position, the starting positions of the PUSCH2 and PUSCH3 are located before the fourth time domain position, and a starting position of a PUSCH4 is located after the fourth time domain position. The terminal device may, based on the schemes of Embodiment 2 mentioned above, determine whether to apply the second TCI state to transmit the PUSCH after the third time domain position and whether to apply the third TCI state to transmit the PUSCH after the fourth time domain position; or the terminal device may, based on the schemes of Embodiment 2 mentioned above, determine whether to apply a beam corresponding to the second TCI state to transmit the PUSCH after the third time domain position, and whether to apply a beam corresponding to the third TCI state to transmit the PUSCH after the fourth time domain position.

Specifically, in Embodiment 2, which scheme the terminal device determining to use is determined based on one or more of Scheme 1 to Scheme 6 of Embodiment 2 configured by the network device, agreed by a protocol, determined according to a capability of the terminal device, or determined by the capability of the terminal device and one or more of Scheme 1 to Scheme 6 of Embodiment 2 configured by the network device. In other words, the network device may configure to use a certain scheme of Scheme 1 to Scheme 6 of Embodiment 2; or the network device may configure to use a certain scheme of Scheme 1 to Scheme 6 of Embodiment 2 based on the capability of the terminal device; or the network device may agree to use a certain scheme of Scheme 1 to Scheme 6 of Embodiment 2 based on a protocol.

In some embodiments, the second TCI information is indicated by DCI, or activated by MAC CE.

In some embodiments, the second TCI information is determined by a default rule, and the default rules include:
a TCI state having a specific QCL association with an SSB initially accessed by the terminal device, for example, the first channel or signal is a DMRS of the PDSCH, or the first channel or signal is a DMRS of the PDCCH, or the first channel or signal is a CSI-RS, etc.
a TCI state having a specific QCL association with an SSB or a CSI-RS initially accessed by the terminal device, for example, the first channel or signal is a DMRS of the PDSCH, the first channel or signal is a DMRS of the PDCCH, or the first channel or signal is a CSI-RS, etc.
a TCI state same as a TCI state of a PUSCH scheduled by an uplink grant (UL grant) in a Random Access Response (RAR) in an initial access process or a random access process of the terminal device, for example, the first channel or signal is a PUSCH, or the first channel or signal is a PUCCH, or the first channel or signal is an SRS, etc.

Thus, in the embodiments of the present application, in the case where the first TCI information is used to determine the first TCI state, the terminal device determines whether to apply the first TCI state to transmit the first channel or signal after the second time domain position, thereby ensuring consistency in beam understanding of the terminal and the network by determining whether to apply the first TCI state to transmit the first channel or signal after the second time domain position. Or, in the case where the first TCI information is used to determine the second TCI state and the third TCI state, the terminal device determines whether to apply the second TCI state to transmit the first channel or signal after the third time domain position, and whether to apply the third TCI state to transmit the first channel and signal after the fourth time domain position, thereby ensuring consistency in beam understanding of the terminal and the network by determining whether to apply the second TCI state to transmit the first channel or signal after the third time domain position, and whether to apply the third TCI state to transmit the first channel and signal after the fourth time domain position.

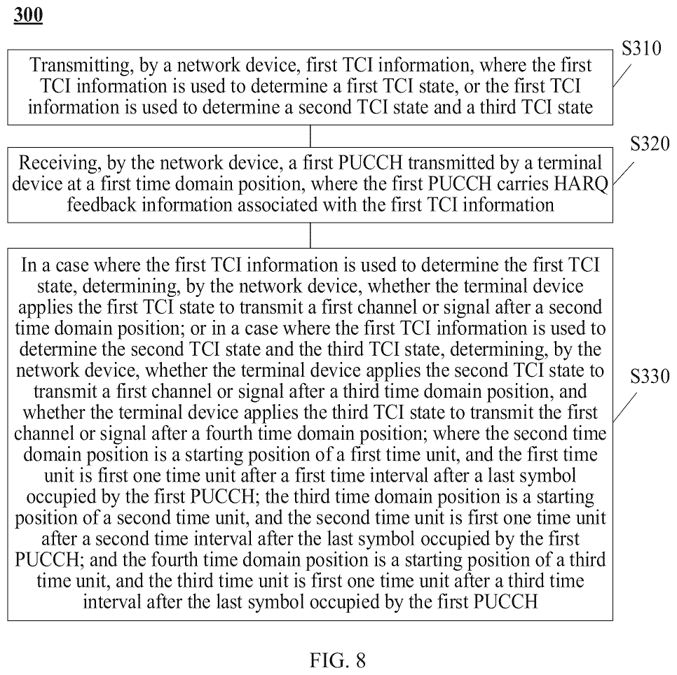

The terminal side embodiments of the present application are described in detail above in conjunction with FIG. 4 to FIG. 7, and network side embodiments of the present application are described in detail below in conjunction with FIG. 8. It should be understood that, the network side embodiments correspond to the terminal side embodiments, and similar descriptions may refer to the terminal side embodiments.

FIG. 8 is a schematic flow chart of a method 300 for wireless communication according to the embodiments of the present application. As shown in FIG. 8, the method 300 for wireless communication may include at least a part of the following contents:
S310, transmitting, by a network device, first TCI information, where the first TCI information is used to determine a first TCI state, or the first TCI information is used to determine a second TCI state and a third TCI state;
S320, receiving, by the network device, a first PUCCH transmitted by a terminal device at a first time domain position, where the first PUCCH carries HARQ feedback information associated with the first TCI information;
S330, in a case where the first TCI information is used to determine the first TCI state, determining, by the network device, whether the terminal device applies the first TCI state to transmit a first channel or signal after a second time domain position; or in a case where the first TCI information is used to determine the second TCI state and the third TCI state, determining, by the network device, whether the terminal device applies the second TCI state to transmit a first channel or signal after a third time domain position, and whether the terminal device applies the third TCI state to transmit the first channel or signal after a fourth time domain position; where the second time domain position is a starting position of a first time unit, and the first time unit is first one time unit after a first time interval after a last symbol occupied by the first PUCCH; the third time domain position is a starting position of a second time unit, and the second time unit is first one time unit after a second time interval after the last symbol occupied by the first PUCCH; and the fourth time domain position is a starting position of a third time unit, and the third time unit is first one time unit after a third time interval after the last symbol occupied by the first PUCCH.

In the embodiments of the present application, the first TCI information is used to determine the first TCI state, which may also be described as that: the first TCI information is used to indicate the first TCI state. Similarly, the first TCI information is used to determine the second TCI state and the third TCI state, which may also be described as that: the first TCI information is used to indicate the second TCI state and the third TCI state.

In the embodiments of the present application, the “first channel or signal” may be understood as: a first channel or a first signal, that is, the first channel or signal may be a channel or a signal.

In some embodiments, the TCI state described in the embodiments of the present application is the unified TCI state.

In the embodiments of the present application, the time unit includes but is not limited to one of: a slot, a symbol, a frame, or a subframe. Specifically, the time unit may be applicable to a part of or all the time units involved in the present application (such as the/a first time unit, the/a second time unit, the/a third time unit, first one time unit, or second one time unit, etc.), which are not limited in the present application.

In the embodiments of the present application, for a scenario of a single carrier, the time interval may adopt an SCS configured by a carrier, or the time interval may adopt a subcarrier spacing configured by an activated BWP, or the time interval may adopt a subcarrier spacing configured by an initial BWP. For a scenario of multiple carriers, the time interval may adopt a minimum SCS configured in the multiple carriers, or the time interval may adopt a minimum SCS configured in an activated BWP of the multiple carriers, or the time interval may adopt a minimum SCS configured in an initial BWP of the multiple carriers, or the time interval may adopt a minimum SCS configured in an initial BWP and an activated BWP of the multiple carriers. Specifically, the time interval may be applicable to a part of or all the time intervals involved in the present application, which are not limited in the present application.

In some embodiments, the first TCI information is carried by the DCI. For example, the first TCI information is an information domain (such as a TCI domain) of the DCI. For example, the HARQ feedback information associated with the first TCI information may be HARQ feedback information corresponding to a channel or signal scheduled by a PDCCH, where the first TCI information is carried by DCI in the PDCCH. Specifically, for example, N TCI states may be configured via RRC, where N is a positive integer; and multiple TCI states (joint TCI states, or uplink TCI states, or downlink TCI states) among the N TCI states may be activated via MAC CE, multiple pairs of uplink and downlink TCI states (for each pair, one uplink and one downlink TCI state) among the N TCI states may be activated via MAC CE, or multiple pairs of uplink TCI states among the N TCI states may be activated via MAC CE, or multiple pairs of downlink TCI states among the N TCI states may be activated via MAC CE, or multiple pairs of joint TCI states among the N TCI states may be activated via MAC CE; further, a specific TCI state may be indicated or determined from the activated TCI states via DCI.

In some embodiments, the first TCI information is carried via MAC CE. For example, the first TCI information is an information domain or field in the MAC CE. For example, the HARQ feedback information associated with the first TCI information may be HARQ feedback information corresponding to a PDSCH, where the first TCI information is carried via MAC CE in the PDSCH. Specifically, for example, N TCI states may be configured via RRC, where N is a positive integer; and a TCI state (a joint TCI state, an uplink TCI state, or a downlink TCI state) among the N TCI states may be activated via MAC CE, or a pair of uplink and downlink TCI states among the N TCI states may be activated via MAC CE, or a pair of uplink TCI states among the N TCI states may be activated via MAC CE, or a pair of downlink TCI states among the N TCI states may be activated via MAC CE, or a pair of joint TCI states among the N TCI states may be activated via MAC CE.

In some embodiments, in a case where the first TCI information is carried by the DCI, the first time interval is Y₁ time units; or, in a case where the first TCI information is carried by the MAC CE, the first time interval is an effective time of the MAC CE.

Specifically, a duration of the effective time of the MAC CE is k+3·Nₛₗₒₜ^{subframe,μ}, where k is a slot in which the PUCCH is located, and μ is a subcarrier spacing configured by the slot of the PUCCH.

In some embodiments, the second time interval is Y₂ time units, and/or the third time interval is Y₃ time units.

Herein, Y₁, Y₂ and Y₃ are all positive integers.

In some embodiments, Y₁ is agreed by a protocol, or Y₁ is configured by a network device according to a minimum beam application time supported by the terminal device; or Y₂ and Y₃ are agreed by a protocol, or Y₂ and Y₃ are configured by the network device according to a minimum beam application time supported by the terminal device. Optionally, values of Y₂ and Y₃ may be different.

Specifically, corresponding to different spatial parameters, the minimum beam application supported by the terminal device may be different, that is, the values of Y₂ and Y₃ may be different.

In some embodiment, the first channel or signal includes at least one of: PUSCH, PUCCH, SRS, PDSCH, PDCCH, aperiodic CSI-RS, or DMRS. Herein, the PUSCH may be a dynamically scheduled PUSCH or a configured PUSCH. That is, the first channel or signal may be an uplink channel or signal, for example, PUSCH, PUCCH, SRS; or the first channel or signal may be a downlink channel or signal, for example, PDSCH, PDCCH, aperiodic CSI-RS, DMRS, etc.

In some embodiments, the first channel or signal is transmitted m times, that is, the number of transmissions of the first channel or signal in time domain is m, and m is a positive integer. For example, the first channel or signal is a PUSCH, the terminal device transmits m repetition transmissions of the PUSCH in time domain, which may be a PUSCH repetition type A (a starting symbol position and an ending symbol position of each PUSCH repetition are the same in time domain), or a PUSCH repetition type B (a slot may be used to transmit multiple PUSCH repetitions); or the terminal device transmits m PUSCHs in time domain, and each PUSCH corresponds to a different transmission layer. For another example, the first channel or signal is a PUCCH, and the terminal device transmits m repetition transmissions of the PUCCH in time domain. For another example, the first channel or signal is an SRS, the terminal device transmits m SRSs in time domain, the m SRSs may be located in one or more slots. For yet another example, the first channel or signal is a PDSCH, the terminal device receives m repeated PDSCHs in time domain, or the terminal device receives m PDSCHs corresponding to different transmission layers in time domain.

In some embodiments, in the case where the first TCI information is used to determine the first TCI state, the first TCI state is a joint TCI state, or the first TCI state is an uplink TCI state, or the first TCI state is a downlink TCI state.

In some embodiments, in a case where the first TCI state is the uplink TCI state, the first TCI information is further used to determine a downlink TCI state; or in a case where the first TCI state is the downlink TCI state, the first TCI information is further used to determine an uplink TCI state.

In some embodiments, in the case where the first TCI information is used to determine the first TCI state, the aforementioned S330 may specifically include: if a starting position of a first transmission of m transmissions of the first channel or signal is located before the second time domain position, determining, by the network device, that the terminal device applies second TCI information in all the m transmissions of the first channel or signal, where the second TCI information is TCI information applied by the terminal device before the second time domain position, and m is a positive integer.

In some embodiments, in the case where the first TCI information is used to determine the first TCI state, the aforementioned S330 may specifically include: if starting positions of first mi transmissions of m transmissions of the first channel or signal are located before the second time domain position, and starting positions of last m-mi transmissions of the m transmissions of the first channel or signal are located after the second time domain position, determining, by the network device, that the terminal device applies the first TCI state to transmit the first channel or signal after the second time domain position; where the first mi transmissions of the m transmissions of the first channel or signal apply second TCI information, and the last m-mi transmissions of the m transmissions of the first channel or signal apply the first TCI state, the second TCI information is TCI information applied by the terminal device before the second time domain position, and m and mi are both positive integers. Optionally, a time interval between an mi-th transmission and an (m₁+1)-th transmission of the first channel or signal is greater than a beam switching time.

In some embodiments, in the case where the first TCI information is used to determine the first TCI state, the aforementioned S330 may specifically include: if starting positions of first m₁ transmissions of m transmissions of the first channel or signal are located before the second time domain position, and starting positions of last m−m₁ transmissions of the m transmissions of the first channel or signal are located after the second time domain position, determining, by the network device, that the terminal device discards the last m−m₁ transmissions of the first channel or signal located after the second time domain position; where the first m₁ transmissions of the m transmissions of the first channel or signal apply second TCI information, the second TCI information is TCI information applied by the terminal device before the second time domain position, and m and mi are both positive integers.

In some embodiments, in the case where the first TCI information is used to determine the first TCI state, the aforementioned S330 may specifically include: if starting positions of first m₁ transmissions of m transmissions of the first channel or signal are located before the second time domain position, and starting positions of last m−m₁ transmissions of the m transmissions of the first channel or signal are located after the second time domain position, determining, by the network device, that the terminal device delays an application time of the first TCI state to an end of the last m−m₁ transmissions of the first channel or signal, or determining, by the network device, that the terminal device delays an application time of the first TCI state to a first time unit after an end of transmissions of the first channel or signal; where the first m₁ transmissions of the m transmissions of the first channel or signal apply second TCI information, the second TCI information is TCI information applied by the terminal device before the second time domain position, and m and mi are both positive integers.

In some embodiments, in the case where the first TCI information is used to determine the second TCI state and the third TCI state, the second time interval is associated with a first spatial parameter, and the third time interval is associated with a second spatial parameter. That is, in the embodiments of the present application, the second time interval and third time interval may be associated with different spatial parameters. Optionally, the spatial parameter may include but be not limited to at least one of: TCI state information, antenna panel information or TRP information, CORESET group information, reference signal set information, capability set information, or beam information.

In some embodiments, the second TCI state and the third TCI state are two uplink TCI states, and the second TCI state and the third TCI state are respectively applied to different transmission layers of an uplink channel, or the second TCI state and the third TCI state are respectively applied to different repetition transmissions of an uplink channel.

In some embodiments, the second TCI state and the third TCI state are two downlink TCI states, and the second TCI state and the third TCI state are respectively applied to different transmission layers of a downlink channel, or the second TCI state and the third TCI state are respectively applied to different repetition transmissions of a downlink channel.

In some embodiments, the second TCI state and the third TCI state are two joint TCI states, and the second TCI state and the third TCI state are respectively applied to different transmission layers of an uplink channel and/or a downlink channel, or the second TCI state and the third TCI state are respectively applied to different repetition transmissions of an uplink channel and/or a downlink channel.

In some embodiments, in the case where the first TCI information is used to determine the second TCI state and the third TCI state, the aforementioned S330 may specifically include: if a starting position of a first transmission of m transmissions of the first channel or signal is earlier than an earlier time domain position in the third time domain position and the fourth time domain position in time domain, determining, by the network device, that the terminal device applies second TCI information in all the m transmissions of the first channel or signal; where the second TCI information is TCI information applied by the terminal device before the earlier time domain position in the third time domain position and the fourth time domain position in time domain, and m is a positive integer.

In some embodiments, in the case where the first TCI information is used to determine the second TCI state and the third TCI state, the aforementioned S330 may specifically include: if a first transmission associated with the first spatial parameter in m transmissions of the first channel or signal is before the third time domain position, determining, by the network device, that the terminal device applies second TCI information in all the m transmissions of the first channel or signal; or if a first transmission associated with the second spatial parameter in m transmissions of the first channel or signal is before the fourth time domain position, determining, by the network device, that the terminal device applies second TCI information in all the m transmissions of the first channel or signal; where the second TCI information is TCI information applied by the terminal device before an earlier time domain position in the third time domain position and the fourth time domain position in time domain, and m is a positive integer.

In some embodiments, in the case where the first TCI information is used to determine the second TCI state and the third TCI state, the aforementioned S330 may specifically include: determining, by the network device, that the terminal device applies the second TCI state in a transmission located after the third time domain position and associated with the first spatial parameter in m transmissions of the first channel or signal, and applies the third TCI state in a transmission located after the fourth time domain position and associated with the second spatial parameter in the m transmissions of the first channel or signal; where m is a positive integer. Optionally, a time interval between two adjacent transmissions associated with a same spatial parameter is greater than a beam switching time.

In some embodiments, in the case where the first TCI information is used to determine the second TCI state and the third TCI state, the aforementioned S330 may specifically include: determining, by the network device, that the terminal device discards a transmission located after the third time domain position and associated with the first spatial parameter in m transmissions of the first channel or signal, and discards a transmission located after the fourth time domain position and associated with the second spatial parameter in the m transmissions of the first channel or signal; where m is a positive integer.

In some embodiments, in the case where the first TCI information is used to determine the second TCI state and the third TCI state, the aforementioned S330 may specifically include: determining, by the network device, that the terminal device delays an application time of the second TCI state and an application time of the third TCI state to an end of m transmissions of the first channel or signal.

In some embodiments, in the case where the first TCI information is used to determine the second TCI state and the third TCI state, the aforementioned S330 may specifically include: determining, by the network device, that the terminal device delays an application time of the second TCI state to an end of a transmission associated with the first spatial parameter in m transmissions of the first channel or signal, or determining, by the network device, that the terminal device delays an application time of the second TCI state to a first time unit after an end of a transmission associated with the first spatial parameter in the m transmissions of the first channel or signal; and determining, by the network device, that the terminal device delays an application time of the third TCI state to an end of a transmission associated with the second spatial parameter in the m transmissions of the first channel or signal, or determining, by the network device, that the terminal device delays an application time of the third TCI state to a first time unit after an end of a transmission associated with the second spatial parameter in the m transmissions of the first channel or signal.

In some embodiments, the first TCI information is carried by DCI, or the first TCI information is carried by an MAC CE.

In some embodiments, in a case where the first TCI information is carried by the DCI, the first time interval is Y₁ time units; or, in a case where the first TCI information is carried by the MAC CE, the first time interval is an effective time of the MAC CE; or the second time interval is Y₂ time units, and/or the third time interval is Y₃ time units; where Y₁, Y₂ and Y₃ are all positive integers.

In some embodiments, Y₁ is agreed by a protocol, or Y₁ is configured by a network device according to a minimum beam application time supported by the terminal device; or Y₂ and Y₃ are agreed by a protocol, or Y₂ and Y₃ are configured by the network device according to a minimum beam application time supported by the terminal device.

In some embodiments, the time unit includes at least one of: a slot, a symbol, a frame, or a subframe.

Thus, in the embodiments of the present application, in the case where the first TCI information is used to determine the first TCI state, the terminal device determines whether to apply the first TCI state to transmit the first channel or signal after the second time domain position, thereby ensuring consistency in beam understanding of the terminal and the network by determining whether to apply the first TCI state to transmit the first channel or signal after the second time domain position. Or, in the case where the first TCI information is used to determine the second TCI state and the third TCI state, the terminal device determines whether to apply the second TCI state to transmit the first channel or signal after the third time domain position, and whether to apply the third TCI state to transmit the first channel and signal after the fourth time domain position, thereby ensuring consistency in beam understanding of the terminal and the network by determining whether to apply the second TCI state to transmit the first channel or signal after the third time domain position, and whether to apply the third TCI state to transmit the first channel and signal after the fourth time domain position.

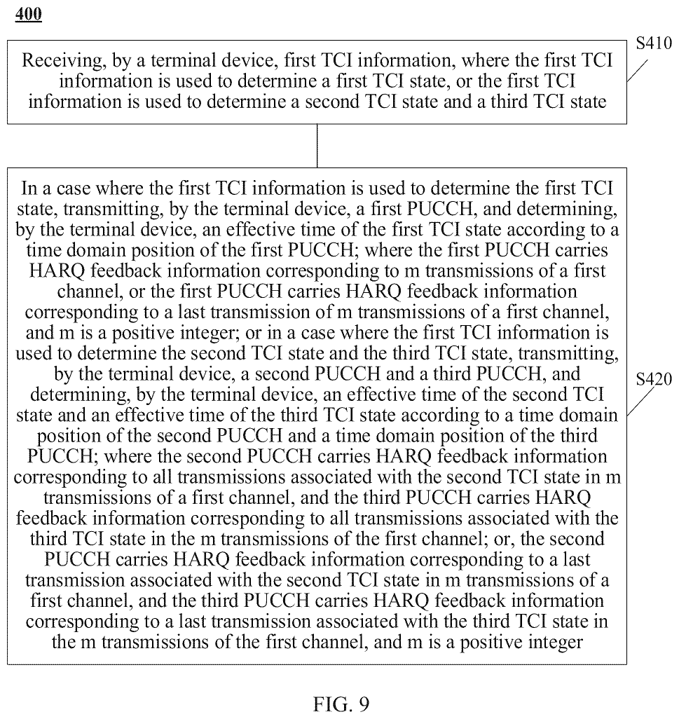

FIG. 9 is a schematic flow chart of a method 400 for wireless communication according to the embodiments of the present application. As shown in FIG. 9, the method 400 for wireless communication may include at least a part of the following contents:
S410, receiving, by a terminal device, first TCI information, where the first TCI information is used to determine a first TCI state, or the first TCI information is used to determine a second TCI state and a third TCI state;
S420, in a case where the first TCI information is used to determine the first TCI state, transmitting, by the terminal device, a first PUCCH, and determining, by the terminal device, an effective time of the first TCI state according to a time domain position of the first PUCCH; where the first PUCCH carries HARQ feedback information corresponding to m transmissions of a first channel, or the first PUCCH carries HARQ feedback information corresponding to a last transmission of m transmissions of a first channel, and m is a positive integer; or in a case where the first TCI information is used to determine the second TCI state and the third TCI state, transmitting, by the terminal device, a second PUCCH and a third PUCCH, and determining, by the terminal device, an effective time of the second TCI state and an effective time of the third TCI state according to a time domain position of the second PUCCH and a time domain position of the third PUCCH; where the second PUCCH carries HARQ feedback information corresponding to all transmissions associated with the second TCI state in m transmissions of a first channel, and the third PUCCH carries HARQ feedback information corresponding to all transmissions associated with the third TCI state in the m transmissions of the first channel; or, the second PUCCH carries HARQ feedback information corresponding to a last transmission associated with the second TCI state in m transmissions of a first channel, and the third PUCCH carries HARQ feedback information corresponding to a last transmission associated with the third TCI state in the m transmissions of the first channel, and m is a positive integer.

In the embodiments of the present application, the first TCI information is used to determine the first TCI state, which may also be described as that: the first TCI information is used to indicate the first TCI state. Similarly, the first TCI information is used to determine the second TCI state and the third TCI state, which may also be described as that: the first TCI information is used to indicate the second TCI state and the third TCI state: In some embodiments, the TCI state described in the embodiments of the present application is the unified TCI state; In some embodiments, the first channel is a PDSCH. Specifically, the PDSCH is scheduled by one PDCCH, and the PDCCH is used to indicate TCI information. Of course, the first channel may be also other channels, which are not limited in the present application.

Specifically, for example, the PDSCH is configured by a PDSCH aggregation factor (pdsch-AggregationFactor) field in a higher layer parameter Semi-Persistent Scheduling Configuration (SPS-config) field, or the PDSCH is configured by a PDSCH aggregation factor (pdsch-AggregationFactor) field in a higher layer parameter PDSCH configuration (PDSCH-Config) field, or the PDSCH is configured with a repetition transmission number (repetitionNumber) or the PDSCH is configured with a time-division multiplexing (TDM) Scheme A (tdmSchemeA).

Specifically, each transmission of the m transmissions of the first channel may be understood as a different repetition transmission of the first channel.

In the embodiments of the present application, the HARQ feedback information of the m transmissions of the first channel may be configured to be fed back jointly or separately, by an RRC signaling.

In some embodiments, the first TCI information is carried by the DCI. For example, the first TCI information is an information domain (such as a TCI domain) of the DCI. Specifically, for example, N TCI states may be configured via RRC, where N is a positive integer; and multiple TCI states (joint TCI states, or uplink TCI states, or downlink TCI states) among the N TCI states may be activated via MAC CE, multiple pairs of uplink and downlink TCI states (for each pair, one uplink and one downlink TCI state) among the N TCI states may be activated via MAC CE, or multiple pairs of uplink TCI states among the N TCI states may be activated via MAC CE, or multiple pairs of downlink TCI states among the N TCI states may be activated via MAC CE, or multiple pairs of joint TCI states among the N TCI states may be activated via MAC CE; further, a specific TCI state may be indicated or determined from the activated TCI states via DCI.

In some embodiments, in the case where the first TCI information is used to determine the first TCI state, the first TCI state is a joint TCI state, or the first TCI state is an uplink TCI state, or the first TCI state is a downlink TCI state. Optionally, in a case where the first TCI state is the uplink TCI state, the first TCI information is further used to determine a downlink TCI state; or in a case where the first TCI state is the downlink TCI state, the first TCI information is further used to determine an uplink TCI state.

In some embodiments, in the case where the first TCI information is used to determine the first TCI state, in the aforementioned S420, the terminal device determines that the first TCI state is effective at a first time domain position; where the first time domain position is a starting position of a first time unit, and the first time unit is first one time unit after a first time interval after a last symbol occupied by the first PUCCH (assuming that it is Scheme 1).

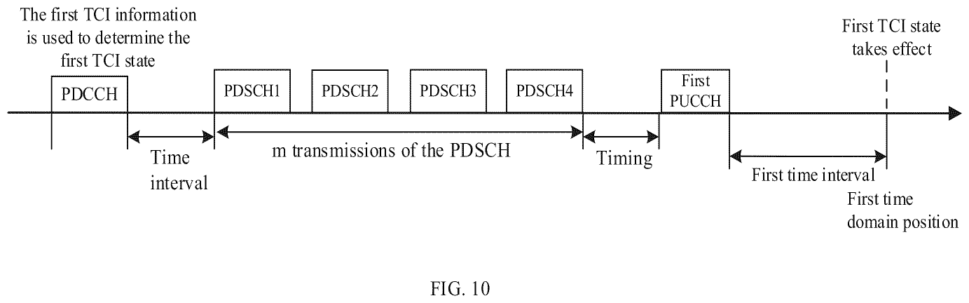

Specifically, for example, as shown in FIG. 10, the first TCI information is carried by DCI in a PDCCH, and the first TCI information is used to determine the first TCI state. As shown in FIG. 10, the first channel is a PDSCH, and the PDSCH is transmitted 4 times in time domain (respectively, PDSCH1 to PDSCH4), the terminal device determines that the first TCI state is effective at the first time domain position.

In some embodiments, the second TCI state and the third TCI state are two uplink TCI states, and the second TCI state and the third TCI state are respectively applied to different transmission layers of an uplink channel, or the second TCI state and the third TCI state are respectively applied to different repetition transmissions of an uplink channel.

In some embodiments, the second TCI state and the third TCI state are two downlink TCI states, and the second TCI state and the third TCI state are respectively applied to different transmission layers of a downlink channel, or the second TCI state and the third TCI state are respectively applied to different repetition transmissions of a downlink channel.

In some embodiments, the second TCI state and the third TCI state are two joint TCI states, and the second TCI state and the third TCI state are respectively applied to different transmission layers of an uplink channel and/or a downlink channel, or the second TCI state and the third TCI state are respectively applied to different repetition transmissions of an uplink channel and/or a downlink channel.

In some embodiments, in the case where the first TCI information is used to determine the second TCI state and the third TCI state, the terminal device is capable of adopting two TCI states to transmit m transmissions of the first channel. For example, when m equals 2, a first transmission and a second transmission of the first channel apply different TCI states. For example, when m is greater than 2, the m transmissions are associated with two TCI states by means of cyclic mapping or sequential mapping, according to a configuration of a higher level. Specifically, each transmission of the m transmissions of the first channel may be understood as different repetition transmissions of the first channel.

In some embodiments, in the case where the first TCI information is used to determine the second TCI state and the third TCI state, in the aforementioned S420, if the time domain position of the second PUCCH is located after the time domain position of the third PUCCH, the terminal device determines that the second TCI state is effective at a second time domain position and the third TCI state is not effective, where the second time domain position is a starting position of a second time unit, and the second time unit is first one time unit after a second time interval after a last symbol occupied by the second PUCCH; or if the time domain position of the second PUCCH is located after the time domain position of the third PUCCH, the terminal device determines that the third TCI state is effective at a third time domain position and the second TCI state is not effective, where the third time domain position is a starting position of a third time unit, and the third time unit is first one time unit after a third time interval after a last symbol of the third PUCCH (assuming that it is Scheme 2). Optionally, the second time interval and the third time interval respectively are associated with different spatial parameters.

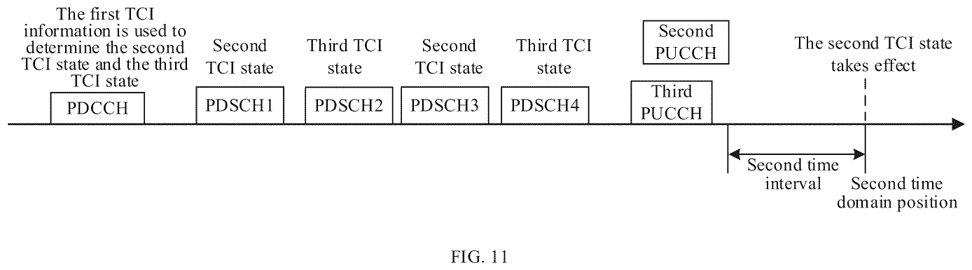

Specifically, for example, as shown in FIG. 11, the first TCI information is carried by DCI in a PDCCH, and the first TCI information is used to determine the second TCI state and the third TCI state. As shown in FIG. 11, the first channel is a PDSCH, and the PDSCH is transmitted 4 times in time domain (respectively, PDSCH1 to PDSCH4), the second PUCCH carries HARQ feedback information corresponding to all transmissions associated with the second TCI state in the m transmissions of the PDSCH, and the third PUCCH carries HARQ feedback information corresponding to all transmissions associated with the third TCI state in the m transmissions of the PDSCH; or the second PUCCH carries HARQ feedback information corresponding to a last transmission associated with the second TCI state in the m transmissions of the PDSCH, and the third PUCCH carries HARQ feedback information corresponding to a last transmission associated with the third TCI state in the m transmissions of the PDSCH. Specifically, the time domain position of the second PUCCH is located after the time domain position of the third PUCCH, as shown in FIG. 11, and the terminal device determines that the second TCI state is effective at the second time domain position, and that the third TCI state is not effective.

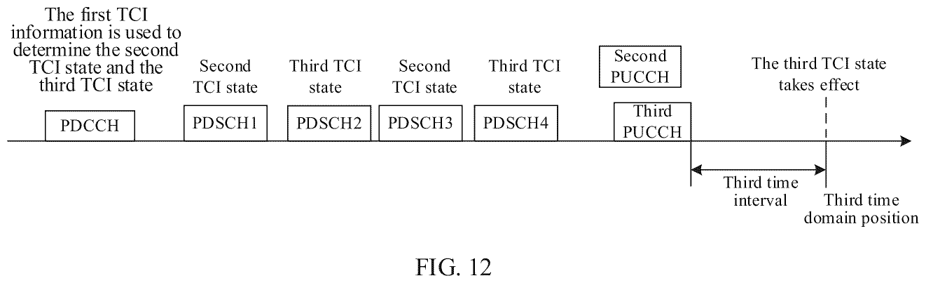

Specifically, for example, as shown in FIG. 12, the first TCI information is carried by DCI in a PDCCH, and the first TCI information is used to determine the second TCI state and the third TCI state. As shown in FIG. 12, the first channel is a PDSCH, and the PDSCH is transmitted 4 times in time domain (respectively, PDSCH1 to PDSCH4), the second PUCCH carries HARQ feedback information corresponding to all transmissions associated with the second TCI state in the m transmissions of the PDSCH, and the third PUCCH carries HARQ feedback information corresponding to all transmissions associated with the third TCI state in the m transmissions of the PDSCH; or the second PUCCH carries HARQ feedback information corresponding to a last transmission associated with the second TCI state in the m transmissions of the PDSCH, and the third PUCCH carries HARQ feedback information corresponding to a last transmission associated with the third TCI state in the m transmissions of the PDSCH. Specifically, the time domain position of the third PUCCH is located after the time domain position of the second PUCCH, as shown in FIG. 12, and the terminal device determines that the third TCI state is effective at the third time domain position, and that the second TCI state is not effective.

In some embodiments, in the case where the first TCI information is used to determine the second TCI state and the third TCI state, in the aforementioned S420, the terminal device determines that the second TCI state is effective at a fourth time domain position, and the third TCI state is effective at a fifth time domain position; where the fourth time domain position is a starting position of a fourth time unit, and the fourth time unit is first one time unit after a fourth time interval after a last symbol occupied by the second PUCCH; the fifth time domain position is a starting position of a fifth time unit, and the fifth time unit is first one time unit after a fifth time interval after a last symbol occupied by the third PUCCH (assuming that it is Scheme 3).

Optionally, the fourth time interval and the fifth time interval are associated with different spatial parameters, respectively.

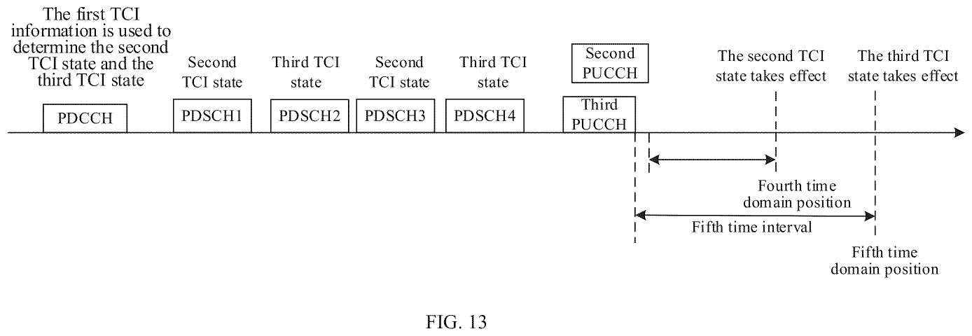

Specifically, for example, as shown in FIG. 13, the first TCI information is carried by DCI in a PDCCH, and the first TCI information is used to determine the second TCI state and the third TCI state. As shown in FIG. 13, the first channel is a PDSCH, and the PDSCH is transmitted 4 times in time domain (respectively, PDSCH1 to PDSCH4), the second PUCCH carries HARQ feedback information corresponding to all transmissions associated with the second TCI state in the m transmissions of the PDSCH, and the third PUCCH carries HARQ feedback information corresponding to all transmissions associated with the third TCI state in the m transmissions of the PDSCH; or the second PUCCH carries HARQ feedback information corresponding to a last transmission associated with the second TCI state in the m transmissions of the PDSCH, and the third PUCCH carries HARQ feedback information corresponding to a last transmission associated with the third TCI state in the m transmissions of the PDSCH. Specifically, as shown in FIG. 13, the terminal device determines that the second TCI state is effective at a fourth time domain position, and the third TCI state is effective at a fifth time domain position.

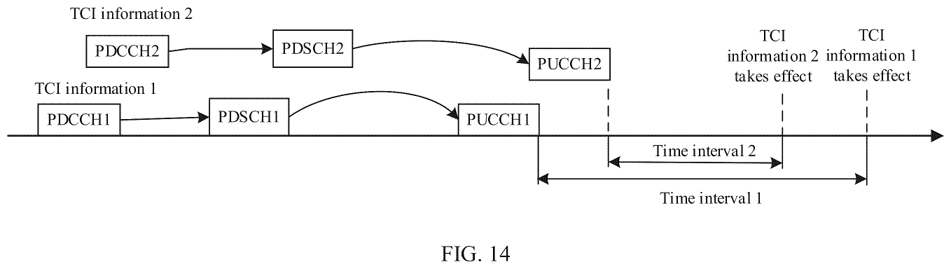

In some embodiments, the terminal device may, according to slots at which respective PUCCHs are located, determine effective times of TCI information carried in the PDCCH1 and PDCCH2. As shown in FIG. 14, TCI information 1 is carried by DCI in the PDCCH1, the PDCCH1 is used to schedule a transmission of the PDSCH1, and HARQ feedback information corresponding to the PDSCH1 is transmitted by the PUCCH1. TCI information 2 is carried by DCI in the PDCCH2, the PDCCH2 is used to schedule a transmission of the PDSCH2, and HARQ feedback information corresponding to the PDSCH2 is transmitted by the PUCCH2. As shown in FIG. 14, the terminal device determines that the TCI information 1 is effective at a time domain position 1, and the TCI information 2 is effective at a time domain position 2. The time domain position 1 is a starting position of a time unit 1, and the time unit 1 is a first time unit after a time interval 1 after a last symbol of the PUCCH1. The time domain position 2 is a starting position of a time unit 2, and the time unit 2 is a first time unit after a time interval 2 after a last symbol of the PUCCH2.

Specifically, which scheme the terminal device determining to use is determined based on one or more of Scheme 1 to Scheme 3 configured by the network device, or agreed by a protocol, determined according to a capability of the terminal device, or determined by the capability of the terminal device and one or more of Scheme 1 to Scheme 3 configured by the network device. In other words, the network device may configure to use a certain scheme of Scheme 1 to Scheme 3; or the network device may configure to use a certain scheme of Scheme 1 to Scheme 3 based on the capability of the terminal device; or the network device may agree to use a certain scheme of Scheme 1 to Scheme 3.

In the embodiments of the present application, the time unit includes but is not limited to one of: a slot, a symbol, a frame, or a subframe. Specifically, the time unit may be applicable to a part of or all the time units involved in the present application (such as a/the first time unit, a/the second time unit, a/the third time unit, first one time unit, or second one time unit, etc.), which are not limited in the present application.

In the embodiments of the present application, for a scenario of a single carrier, the time interval may adopt an SCS configured by a carrier, or the time interval may adopt a subcarrier spacing configured by an activated BWP, or the time interval may adopt a subcarrier spacing configured by an initial BWP. For a scenario of multiple carriers, the time interval may adopt a minimum SCS configured in the multiple carriers, or the time interval may adopt a minimum SCS configured in an activated BWP of the multiple carriers, or the time interval may adopt a minimum SCS configured in an initial BWP of the multiple carriers, or the time interval may adopt a minimum SCS configured in an initial BWP and an activated BWP of the multiple carriers. Specifically, the time interval may be applicable to a part of or all the time intervals involved in the present application (such as a/the first time interval, a/the second time interval, a/the third time interval, a/the fourth time interval, or a/the fifth time interval), which are not limited in the present application.

In some embodiments, the spatial parameter may include but be not limited to at least one of: TCI state information, antenna panel information or TRP information, CORESET group information, reference signal set information, capability set information, or beam information.

In some embodiments, the antenna panel information may include an antenna panel identity (ID) or index.

In some embodiments, the TRP information may include a TRP ID or index.

In some embodiments, the CORESET group information may include a CORESET group ID or index.

In some embodiments, reference signal set information may be Synchronization Signal Block (SSB) resource set information, Channel State Information Reference Signal (CSI-RS) resource set information, or SRS resource set information.

For example, reference signal set information may include an index of a reference signal set, for example an index of an SSB set, an index of a CSI-RS resource set, or an index of an SRS resource set.

In some embodiments, reference signal information may include SSB resource information, CSI-RS resource information or SRS resource information. For example, reference signal information may be an index of an SRS resource, an SSB resource, or a CSI-RS resource.

In some embodiments, the beam information may include a beam identity (ID) or index.

In the embodiments of the present application, a beam may also be called as a spatial domain transmission filter or spatial domain filter for transmission, or a spatial domain reception filter or spatial domain filter for reception, or a spatial reception parameter (spatial Rx parameter).

In some embodiments, the capability set information may include one or more parameters. For example, the capability set information may be a capability set supported by the terminal device or reference signal information associated with a capability set supported by the terminal device.

In some embodiments, the capability set information includes but is not limited to at least one of:
a maximum number of SRS ports, a maximum number of uplink transmission layers, a codebook subset type, an uplink full-power transmission mode, an SRS antenna switching capability, an SRS carrier switching capability, a number of SRS resources transmitted simultaneously, a maximum modulation method for an uplink data transmission, a maximum modulation method for an downlink data transmission, a number of hybrid automatic repeat request (HARQ) processes supported by the terminal device, a channel bandwidth supported by the terminal device, a number of transmission antennas supported by the terminal device, a PDSCH processing capability, a PUSCH processing capability, power saving capability of the terminal device, coverage enhancement capability of the terminal device, an improvement capability of data transmission rate of the terminal device, a short latency processing capability of the terminal device, a small data transmission capability of the terminal device, a non-active data transmission capability of the terminal device, a transmission reliability capability of the terminal device, or an ultra-reliable and low latency communication (URLLC) data transmission capability of the terminal device.

Thus, in the case where the first TCI information is used to determine the first TCI state, the terminal device transmits the first PUCCH, and the terminal device determines the effective time of the first TCI state according to the time domain position of the first PUCCH, thereby ensuring consistency in beam understanding of the terminal and the network by determining the beam application time. In the case where the first TCI information is used to determine the second TCI state and the third TCI state, the terminal device transmits the second PUCCH and the third PUCCH, and the terminal device determines the effective time of the second TCI state and the effective time of the third TCI state according to the time domain position of the second PUCCH and the time domain position of the third PUCCH, thereby ensuring consistency in beam understanding of the terminal and the network by determining the beam application time.

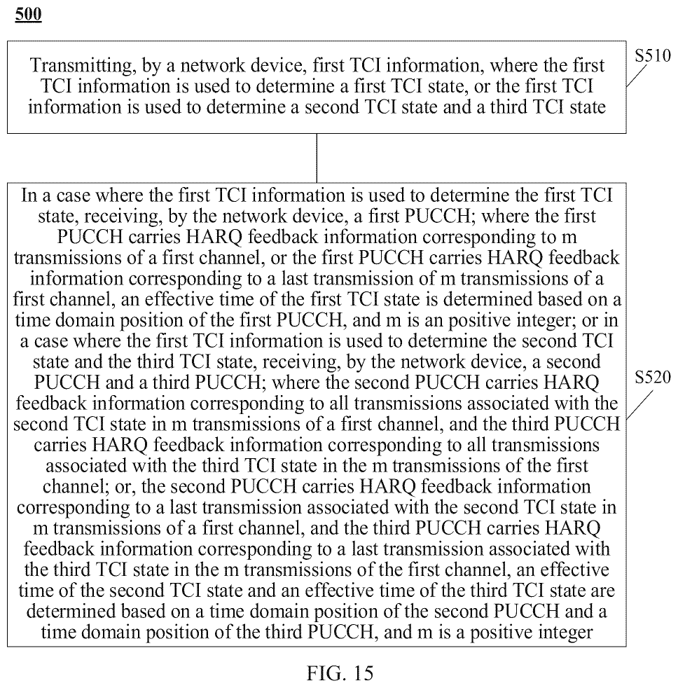

The terminal side embodiments of the present application are described in detail above in conjunction with FIG. 9 to FIG. 14, and network side embodiments of the present application are described in detail below in conjunction with FIG. 15. It should be understood that, the network side embodiments correspond to the terminal side embodiments, and similar descriptions may refer to the terminal side embodiments.

FIG. 15 is a schematic flow chart of a method 500 for wireless communication according to the embodiments of the present application. As shown in FIG. 15, the method 500 for wireless communication may include at least a part of the following contents:
S510, transmitting, by a network device, first TCI information, where the first TCI information is used to determine a first TCI state, or the first TCI information is used to determine a second TCI state and a third TCI state;
S520, in a case where the first TCI information is used to determine the first TCI state, receiving, by the network device, a first PUCCH; where the first PUCCH carries HARQ feedback information corresponding to m transmissions of a first channel, or the first PUCCH carries HARQ feedback information corresponding to a last transmission of m transmissions of a first channel, an effective time of the first TCI state is determined based on a time domain position of the first PUCCH, and m is an positive integer; or in a case where the first TCI information is used to determine the second TCI state and the third TCI state, receiving, by the network device, a second PUCCH and a third PUCCH; where the second PUCCH carries HARQ feedback information corresponding to all transmissions associated with the second TCI state in m transmissions of a first channel, and the third PUCCH carries HARQ feedback information corresponding to all transmissions associated with the third TCI state in the m transmissions of the first channel; or, the second PUCCH carries HARQ feedback information corresponding to a last transmission associated with the second TCI state in m transmissions of a first channel, and the third PUCCH carries HARQ feedback information corresponding to a last transmission associated with the third TCI state in the m transmissions of the first channel, an effective time of the second TCI state and an effective time of the third TCI state are determined based on a time domain position of the second PUCCH and a time domain position of the third PUCCH, and m is an positive integer.

In the embodiments of the present application, the first TCI information is used to determine the first TCI state, which may also be described as that: the first TCI information is used to indicate the first TCI state. Similarly, the first TCI information is used to determine the second TCI state and the third TCI state, which may also be described as that: the first TCI information is used to indicate the second TCI state and the third TCI state.

In some embodiments, the TCI state described in the embodiments of the present application is the unified TCI state.

In some embodiments, the first channel is a PDSCH. Specifically, the PDSCH is scheduled by one PDCCH, and the PDCCH is used to indicate TCI information. Of course, the first channel may be also other channels, which are not limited in the present application.

Specifically, for example, the PDSCH is configured by a PDSCH aggregation factor (pdsch-AggregationFactor) field in a higher layer parameter Semi-Persistent Scheduling Configuration (SPS-config) field, or the PDSCH is configured by a PDSCH aggregation factor (pdsch-AggregationFactor) field in a higher layer parameter PDSCH configuration (PDSCH-Config) field, or the PDSCH is configured with a repetition transmission number (repetitionNumber) or the PDSCH is configured with a time-division multiplexing (TDM) Scheme A (tdmSchemeA).

In the embodiments of the present application, the HARQ feedback information of the m transmissions of the first channel may be configured to be fed back jointly or separately, by an RRC signaling.

In some embodiments, the first TCI information is carried by the DCI. For example, the first TCI information is an information domain (such as a TCI domain) of the DCI. Specifically, for example, N TCI states may be configured via RRC, where N is a positive integer; and multiple TCI states (joint TCI states, or uplink TCI states, or downlink TCI states) among the N TCI states may be activated via MAC CE, multiple pairs of uplink and downlink TCI states (for each pair, one uplink and one downlink TCI state) among the N TCI states may be activated via MAC CE, or multiple pairs of uplink TCI states among the N TCI states may be activated via MAC CE, or multiple pairs of downlink TCI states among the N TCI states may be activated via MAC CE, or multiple pairs of joint TCI states among the N TCI states may be activated via MAC CE; further, a specific TCI state may be indicated or determined from the activated TCI states via DCI.

In some embodiments, in the case where the first TCI information is used to determine the first TCI state, the first TCI state is a joint TCI state, or the first TCI state is an uplink TCI state, or the first TCI state is a downlink TCI state. Optionally, in a case where the first TCI state is the uplink TCI state, the first TCI information is further used to determine a downlink TCI state; or in a case where the first TCI state is the downlink TCI state, the first TCI information is further used to determine an uplink TCI state.

In some embodiments, in the case where the first TCI information is used to determine the first TCI state, the first TCI state is effective at a first time domain position; where the first time domain position is a starting position of a first time unit, and the first time unit is first one time unit after a first time interval after a last symbol occupied by the first PUCCH.

In some embodiments, the second TCI state and the third TCI state are two uplink TCI states, and the second TCI state and the third TCI state are respectively applied to different transmission layers of an uplink channel, or the second TCI state and the third TCI state are respectively applied to different repetition transmissions of an uplink channel.

In some embodiments, the second TCI state and the third TCI state are two downlink TCI states, and the second TCI state and the third TCI state are respectively applied to different transmission layers of a downlink channel, or the second TCI state and the third TCI state are respectively applied to different repetition transmissions of a downlink channel.

In some embodiments, the second TCI state and the third TCI state are two joint TCI states, and the second TCI state and the third TCI state are respectively applied to different transmission layers of an uplink channel and/or a downlink channel, or the second TCI state and the third TCI state are respectively applied to different repetition transmissions of an uplink channel and/or a downlink channel.

In some embodiments, in the case where the first TCI information is used to determine the second TCI state and the third TCI state, if the time domain position of the second PUCCH is located after the time domain position of the third PUCCH, the second TCI state is effective at a second time domain position and the third TCI state is not effective, where the second time domain position is a starting position of a second time unit, and the second time unit is first one time unit after a second time interval after a last symbol occupied by the second PUCCH.

In some embodiments, in a case where the first TCI information is used to determine the second TCI state and the third TCI state, if the time domain position of the second PUCCH is located after the time domain position of the third PUCCH, the third TCI state is effective at a third time domain position and the second TCI state is not effective, where the third time domain position is a starting position of a third time unit, and the third time unit is first one time unit after a third time interval after a last symbol of the third PUCCH.

In some embodiments, the second time interval and the third time interval are respectively associated with different spatial parameters.

In some embodiments, in the case where the first TCI information is used to determine the second TCI state and the third TCI state, the second TCI state is effective at a fourth time domain position, and the third TCI state is effective at a fifth time domain position; where the fourth time domain position is a starting position of a fourth time unit, and the fourth time unit is first one time unit after a fourth time interval after a last symbol occupied by the second PUCCH; the fifth time domain position is a starting position of a fifth time unit, and the fifth time unit is first one time unit after a fifth time interval after a last symbol occupied by the third PUCCH.

In some embodiments, the fourth time interval and the fifth time interval are associated with different spatial parameters, respectively.

In the embodiments of the present application, the time unit includes but is not limited to one of: a slot, a symbol, a frame, or a subframe. Specifically, the time unit may be applicable to a part of or all the time units involved in the present application (such as a/the first time unit, a/the second time unit, a/the third time unit, first one time unit, or second one time unit, etc.), which are not limited in the present application.

In the embodiments of the present application, for a scenario of a single carrier, the time interval may adopt an SCS configured by a carrier, or the time interval may adopt a subcarrier spacing configured by an activated BWP, or the time interval may adopt a subcarrier spacing configured by an initial BWP. For a scenario of multiple carriers, the time interval may adopt a minimum SCS configured in the multiple carriers, or the time interval may adopt a minimum SCS configured in an activated BWP of the multiple carriers, or the time interval may adopt a minimum SCS configured in an initial BWP of the multiple carriers, or the time interval may adopt a minimum SCS configured in an initial BWP and an activated BWP of the multiple carriers.

Specifically, the time interval may be applicable to a part of or all the time intervals involved in the present application (such as a/the first time interval, a/the second time interval, a/the third time interval, a/the fourth time interval, or a/the fifth time interval), which are not limited in the present application.

In some embodiments, the spatial parameter may include but be not limited to at least one of: TCI state information, antenna panel information or TRP information, CORESET group information, reference signal set information, capability set information, or beam information.

Thus, in the embodiments of the present application, in the case where the first TCI information is used to determine the first TCI state, the terminal device transmits the first PUCCH, and the terminal device determines the effective time of the first TCI state according to the time domain position of the first PUCCH, thereby ensuring consistency in beam understanding of the terminal and the network by determining the beam application time. In the case where the first TCI information is used to determine the second TCI state and the third TCI state, the terminal device transmits the second PUCCH and the third PUCCH, and the terminal device determines the effective time of the second TCI state and the effective time of the third TCI state according to the time domain position of the second PUCCH and the time domain position of the third PUCCH, thereby ensuring consistency in beam understanding of the terminal and the network by determining the beam application time.

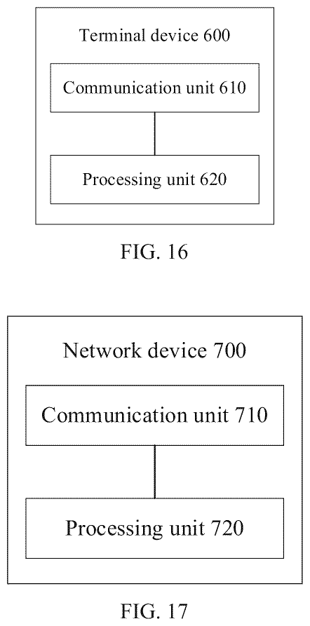

The method embodiments of the present application are described in detail above in conjunction with FIG. 4 to FIG. 15, and apparatus embodiments of the present application are described in detail below in conjunction with FIG. 16 to FIG. 19. It should be understood that, the apparatus embodiments correspond to the method embodiments, and similar descriptions may refer to the method embodiments.

FIG. 16 illustrates a schematic block diagram of a terminal device 600 according to the embodiments of the present application. As shown in FIG. 16, the terminal device 600 includes: a communication unit 610 and a processing unit 620; where, the communication unit 610 is configured to receive first transmission configuration indicator (TCI) information, where the first TCI information is used to determine a first TCI state, or the first TCI information is used to determine a second TCI state and a third TCI state; the communication unit 610 is further configured to transmit a first physical uplink control channel (PUCCH) at a first time domain position, where the first PUCCH carries hybrid automatic repeat request (HARQ) feedback information associated with the first TCI information; in a case where the first TCI information is used to determine the first TCI state, the processing unit 620 is configured to determine whether to apply the first TCI state to transmit a first channel or signal after a second time domain position; or in a case where the first TCI information is used to determine the second TCI state and the third TCI state, the processing unit 620 is configured to determine whether to apply the second TCI state to transmit a first channel or signal after a third time domain position, and whether to apply the third TCI state to transmit the first channel or signal after a fourth time domain position; where the second time domain position is a starting position of a first time unit, and the first time unit is first one time unit after a first time interval after a last symbol occupied by the first PUCCH; the third time domain position is a starting position of a second time unit, and the second time unit is first one time unit after a second time interval after the last symbol occupied by the first PUCCH; and the fourth time domain position is a starting position of a third time unit, and the third time unit is first one time unit after a third time interval after the last symbol occupied by the first PUCCH.

In some embodiments, in the case where the first TCI information is used to determine the first TCI state, the first TCI state is a joint TCI state, or the first TCI state is an uplink TCI state, or the first TCI state is a downlink TCI state.

In some embodiments, in a case where the first TCI state is the uplink TCI state, the first TCI information is further used to determine a downlink TCI state; or in a case where the first TCI state is the downlink TCI state, the first TCI information is further used to determine an uplink TCI state.

In some embodiments, the processing unit 620 is specifically configured to:
if a starting position of a first transmission of m transmissions of the first channel or signal is located before the second time domain position, determine that second TCI information is applied to all the m transmissions of the first channel or signal, where the second TCI information is TCI information applied by the terminal device before the second time domain position, and m is a positive integer.

In some embodiments, the processing unit 620 is specifically configured to:
if starting positions of first m₁ transmissions of m transmissions of the first channel or signal are located before the second time domain position, and starting positions of last m−m₁ transmissions of the m transmissions of the first channel or signal are located after the second time domain position, determine to apply the first TCI state to transmit the first channel or signal after the second time domain position;
where the first m₁ transmissions of the m transmissions of the first channel or signal apply second TCI information, and the last m−m₁ transmissions of the m transmissions of the first channel or signal apply the first TCI state, the second TCI information is TCI information applied by the terminal device before the second time domain position, and m and mi are both positive integers.

In some embodiments, a time interval between an mi-th transmission and an (m₁+1)-th transmission of the first channel or signal is greater than a beam switching time.

In some embodiments, the processing unit 620 is specifically configured to:
if starting positions of first m₁ transmissions of m transmissions of the first channel or signal are located before the second time domain position, and starting positions of last m−m₁ transmissions of the m transmissions of the first channel or signal are located after the second time domain position, determine to discard the last m−m₁ transmissions of the first channel or signal located after the second time domain position;
where the first m₁ transmissions of the m transmissions of the first channel or signal apply second TCI information, the second TCI information is TCI information applied by the terminal device before the second time domain position, and m and mi are both positive integers.

In some embodiments, the processing unit 620 is specifically configured to:
if starting positions of first m₁ transmissions of m transmissions of the first channel or signal are located before the second time domain position, and starting positions of last m−m₁ transmissions of the m transmissions of the first channel or signal are located after the second time domain position, determine to delay an application time of the first TCI state to an end of the last m−m₁ transmissions of the first channel or signal, or determine to delay an application time of the first TCI state to a first time unit after an end of transmissions of the first channel or signal;
where the first m₁ transmissions of the m transmissions of the first channel or signal apply second TCI information, the second TCI information is TCI information applied by the terminal device before the second time domain position, and m and mi are both positive integers.

In some embodiments, in the case where the first TCI information is used to determine the second TCI state and the third TCI state, the second time interval is associated with a first spatial parameter, and the third time interval is associated with a second spatial parameter.

In some embodiments, the second TCI state and the third TCI state are two uplink TCI states, and the second TCI state and the third TCI state are respectively applied to different transmission layers of an uplink channel, or the second TCI state and the third TCI state are respectively applied to different repetition transmissions of an uplink channel; or
the second TCI state and the third TCI state are two downlink TCI states, and the second TCI state and the third TCI state are respectively applied to different transmission layers of a downlink channel, or the second TCI state and the third TCI state are respectively applied to different repetition transmissions of a downlink channel; or
the second TCI state and the third TCI state are two joint TCI states, and the second TCI state and the third TCI state are respectively applied to different transmission layers of an uplink channel and/or a downlink channel, or the second TCI state and the third TCI state are respectively applied to different repetition transmissions of an uplink channel and/or a downlink channel.

In some embodiments, the processing unit 620 is specifically configured to:
if a starting position of a first transmission of m transmissions of the first channel or signal is earlier than an earlier time domain position in the third time domain position and the fourth time domain position in time domain, determine that the m transmissions of the first channel or signal all apply second TCI information;
where the second TCI information is TCI information applied by the terminal device before the earlier time domain position in the third time domain position and the fourth time domain position in time domain, and m is a positive integer.

In some embodiments, the processing unit 620 is specifically configured to:
if a first transmission associated with the first spatial parameter in m transmissions of the first channel or signal is before the third time domain position, determine that the m transmissions of the first channel or signal all apply second TCI information; or
if a first transmission associated with the second spatial parameter in m transmissions of the first channel or signal is before the fourth time domain position, determine that the m transmissions of the first channel or signal all apply second TCI information;
where the second TCI information is TCI information applied by the terminal device before an earlier time domain position in the third time domain position and the fourth time domain position in time domain, and m is a positive integer.

In some embodiments, the processing unit 620 is specifically configured to:
determine that a transmission located after the third time domain position and associated with the first spatial parameter in m transmissions of the first channel or signal applies the second TCI state, and that a transmission located after the fourth time domain position and associated with the second spatial parameter in the m transmissions of the first channel or signal applies the third TCI state;
where m is a positive integer.

In some embodiments, a time interval between two adjacent transmissions associated with a same spatial parameter is greater than a beam switching time.

In some embodiments, the processing unit 620 is specifically configured to:
determine to discard a transmission located after the third time domain position and associated with the first spatial parameter in m transmissions of the first channel or signal, and to discard a transmission located after the fourth time domain position and associated with the second spatial parameter in the m transmissions of the first channel or signal;
where m is a positive integer.

In some embodiments, the processing unit 620 is specifically configured to: determine to delay an application time of the second TCI state and an application time of the third TCI state to an end of m transmissions of the first channel or signal; or the processing unit 620 is specifically configured to: determine to delay an application time of the second TCI state to an end of a transmission associated with the first spatial parameter in m transmissions of the first channel or signal, or determine to delay an application time of the second TCI state to a first time unit after an end of a transmission associated with the first spatial parameter in the m transmissions of the first channel or signal; and determine to delay an application time of the third TCI state to an end of a transmission associated with the second spatial parameter in the m transmissions of the first channel or signal, or determine to delay an application time of the third TCI state to a first time unit after an end of a transmission associated with the second spatial parameter in the m transmissions of the first channel or signal;
where m is a positive integer.

In some embodiments, the first TCI information is carried by downlink control information (DCI), or the first TCI information is carried by a media access control layer control element (MAC CE).

In some embodiments, in a case where the first TCI information is carried by the DCI, the first time interval is Y₁ time units; or, in a case where the first TCI information is carried by the MAC CE, the first time interval is an effective time of the MAC CE; or the second time interval is Y₂ time units, and/or the third time interval is Y₃ time units;
where Y₁, Y₂ and Y₃ are all positive integers.

In some embodiments, Y₁ is agreed by a protocol, or Y₁ is configured by a network device according to a minimum beam application time supported by the terminal device; or Y₂ and Y₃ are agreed by a protocol, or Y₂ and Y₃ are configured by the network device according to a minimum beam application time supported by the terminal device.

In some embodiments, the time unit includes at least one of: a slot, a symbol, a frame, or a subframe.

In some embodiments, the aforementioned communication unit may be a communication interface or transceiver, or an input/output interface of a communication chip or a system on chip.

The aforementioned processing unit may be one or more processors.

It should be understood that the terminal device 600 according to the embodiments of the present application may correspond to the terminal device of the method embodiments of the present application, and the above or other operations and/or functions of each unit in the terminal device 600 is respectively to implement the corresponding processes of the terminal device in the method 200 shown in FIG. 4, which are not repeated herein for the sake of brevity.

FIG. 17 illustrates a schematic block diagram of a network device 700 according to the embodiments of the present application. As shown in FIG. 17, the network device 700 includes: a communication unit 710 and a processing unit 720; where, the communication unit 710 is configured to transmit first transmission configuration indicator (TCI) information, where the first TCI information is used to determine a first TCI state, or the first TCI information is used to determine a second TCI state and a third TCI state; the communication unit 710 is further configured to receive a first physical uplink control channel (PUCCH) transmitted by a terminal device at a first time domain position, where the first PUCCH carries hybrid automatic repeat request (HARQ) feedback information associated with the first TCI information;
in a case where the first TCI information is used to determine the first TCI state, the processing unit 720 is configured to determine whether the terminal device applies the first TCI state to transmit a first channel or signal after a second time domain position; or in a case where the first TCI information is used to determine the second TCI state and the third TCI state, the processing unit 720 is configured to determine whether the terminal device applies the second TCI state to transmit a first channel or signal after a third time domain position, and whether the terminal device applies the third TCI state to transmit the first channel or signal after a fourth time domain position;
where the second time domain position is a starting position of a first time unit, and the first time unit is first one time unit after a first time interval after a last symbol occupied by the first PUCCH; the third time domain position is a starting position of a second time unit, and the second time unit is first one time unit after a second time interval after the last symbol occupied by the first PUCCH; and the fourth time domain position is a starting position of a third time unit, and the third time unit is first one time unit after a third time interval after the last symbol occupied by the first PUCCH.

In some embodiments, in the case where the first TCI information is used to determine the first TCI state, the first TCI state is a joint TCI state, or the first TCI state is an uplink TCI state, or the first TCI state is a downlink TCI state.

In some embodiments, in a case where the first TCI state is the uplink TCI state, the first TCI information is further used to determine a downlink TCI state; or in a case where the first TCI state is the downlink TCI state, the first TCI information is further used to determine an uplink TCI state.

In some embodiments, the processing unit 720 is specifically configured to:
if a starting position of a first transmission of m transmissions of the first channel or signal is located before the second time domain position, determine that the terminal device applies second TCI information in all the m transmissions of the first channel or signal, where the second TCI information is TCI information applied by the terminal device before the second time domain position, and m is a positive integer.

In some embodiments, the processing unit 720 is specifically configured to:
if starting positions of first m₁ transmissions of m transmissions of the first channel or signal are located before the second time domain position, and starting positions of last m−m₁ transmissions of the m transmissions of the first channel or signal are located after the second time domain position, determine that the terminal device applies the first TCI state to transmit the first channel or signal after the second time domain position;
where the first m₁ transmissions of the m transmissions of the first channel or signal apply second TCI information, and the last m−m₁ transmissions of the m transmissions of the first channel or signal apply the first TCI state, the second TCI information is TCI information applied by the terminal device before the second time domain position, and m and mi are both positive integers.

In some embodiments, a time interval between an mi-th transmission and an (m₁+1)-th transmission of the first channel or signal is greater than a beam switching time.

In some embodiments, the processing unit 720 is specifically configured to:
if starting positions of first m₁ transmissions of m transmissions of the first channel or signal are located before the second time domain position, and starting positions of last m−m₁ transmissions of the m transmissions of the first channel or signal are located after the second time domain position, determine that the terminal device discards the last m−m₁ transmissions of the first channel or signal located after the second time domain position;
where the first m₁ transmissions of the m transmissions of the first channel or signal apply second TCI information, the second TCI information is TCI information applied by the terminal device before the second time domain position, and m and mi are both positive integers.

In some embodiments, the processing unit 720 is specifically configured to:
if starting positions of first m₁ transmissions of m transmissions of the first channel or signal are located before the second time domain position, and starting positions of last m−m₁ transmissions of the m transmissions of the first channel or signal are located after the second time domain position, determine that the terminal device delays an application time of the first TCI state to an end of the last m−m₁ transmissions of the first channel or signal, or determine that the terminal device delays an application time of the first TCI state to a first time unit after an end of transmissions of the first channel or signal;
where the first m₁ transmissions of the m transmissions of the first channel or signal apply second TCI information, the second TCI information is TCI information applied by the terminal device before the second time domain position, and m and mi are both positive integers.

In some embodiments, in the case where the first TCI information is used to determine the second TCI state and the third TCI state, the second time interval is associated with a first spatial parameter, and the third time interval is associated with a second spatial parameter.

In some embodiments, the second TCI state and the third TCI state are two uplink TCI states, and the second TCI state and the third TCI state are respectively applied to different transmission layers of an uplink channel, or the second TCI state and the third TCI state are respectively applied to different repetition transmissions of an uplink channel; or
the second TCI state and the third TCI state are two downlink TCI states, and the second TCI state and the third TCI state are respectively applied to different transmission layers of a downlink channel, or the second TCI state and the third TCI state are respectively applied to different repetition transmissions of a downlink channel; or
the second TCI state and the third TCI state are two joint TCI states, and the second TCI state and the third TCI state are respectively applied to different transmission layers of an uplink channel and/or a downlink channel, or the second TCI state and the third TCI state are respectively applied to different repetition transmissions of an uplink channel and/or a downlink channel.

In some embodiments, the processing unit 720 is specifically configured to:
if a starting position of a first transmission of m transmissions of the first channel or signal is earlier than an earlier time domain position in the third time domain position and the fourth time domain position in time domain, determine that the terminal device applies second TC information in all the m transmissions of the first channel or signal;
where the second TCI information is TCI information applied by the terminal device before the earlier time domain position in the third time domain position and the fourth time domain position in time domain, and m is a positive integer.

In some embodiments, the processing unit 720 is specifically configured to:
if a first transmission associated with the first spatial parameter in m transmissions of the first channel or signal is before the third time domain position, determine that the terminal device applies second TCI information in all the m transmissions of the first channel or signal; or
if a first transmission associated with the second spatial parameter in m transmissions of the first channel or signal is before the fourth time domain position, determine that the terminal device applies second TCI information in all the m transmissions of the first channel or signal;
where the second TCI information is TCI information applied by the terminal device before an earlier time domain position in the third time domain position and the fourth time domain position in time domain, and m is a positive integer.

In some embodiments, the processing unit 720 is specifically configured to:
determine that the terminal device applies the second TCI state in a transmission located after the third time domain position and associated with the first spatial parameter in m transmissions of the first channel or signal, and applies the third TCI state in a transmission located after the fourth time domain position and associated with the second spatial parameter in the m transmissions of the first channel or signal;
where m is a positive integer.

In some embodiments, a time interval between two adjacent transmissions associated with a same spatial parameter is greater than a beam switching time.

In some embodiments, the processing unit 720 is specifically configured to:
determine that the terminal device discards a transmission located after the third time domain position and associated with the first spatial parameter in m transmissions of the first channel or signal, and discards a transmission located after the fourth time domain position and associated with the second spatial parameter in the m transmissions of the first channel or signal;
where m is a positive integer.

In some embodiments, the processing unit 720 is specifically configured to:
determine that the terminal device delays an application time of the second TCI state and an application time of the third TCI state to an end of m transmissions of the first channel or signal; or
determine that the terminal device delays an application time of the second TCI state to an end of a transmission associated with the first spatial parameter in m transmissions of the first channel or signal, or determine that the terminal device delays an application time of the second TCI state to a first time unit after an end of a transmission associated with the first spatial parameter in the m transmissions of the first channel or signal; and determine that the terminal device delays an application time of the third TCI state to an end of a transmission associated with the second spatial parameter in the m transmissions of the first channel or signal, or determine that the terminal device delays an application time of the third TCI state to a first time unit after an end of a transmission associated with the second spatial parameter in the m transmissions of the first channel or signal;
where m is a positive integer.

In some embodiments, the first TCI information is carried by downlink control information (DCI), or the first TCI information is carried by a media access control layer control element (MAC CE).

In some embodiments, in a case where the first TCI information is carried by the DCI, the first time interval is Y₁ time units; or, in a case where the first TCI information is carried by the MAC CE, the first time interval is an effective time of the MAC CE; or the second time interval is Y₂ time units, and/or the third time interval is Y₃ time units;
where Y₁, Y₂ and Y₃ are all positive integers.

In some embodiments, Y₁ is agreed by a protocol, or Y₁ is configured by a network device according to a minimum beam application time supported by the terminal device; or Y₂ and Y₃ are agreed by a protocol, or Y₂ and Y₃ are configured by the network device according to a minimum beam application time supported by the terminal device.

In some embodiments, the time unit includes at least one of: a slot, a symbol, a frame, or a subframe.

In some embodiments, the aforementioned communication unit may be a communication interface or transceiver, or an input/output interface of a communication chip or a system on chip. The aforementioned processing unit may be one or more processors.

It should be understood that the network device 700 according to the embodiments of the present application may correspond to the network device of the method embodiments of the present application, and the above or other operations and/or functions of each unit in the network device 700 is respectively to implement the corresponding processes of the network device in the method 300 shown in FIG. 8, which are not repeated herein for the sake of brevity.

FIG. 18 illustrates a schematic block diagram of a terminal device 800 according to the embodiments of the present application. As shown in FIG. 18, the terminal device 800 includes: a communication unit 810 and a processing unit 820; where,
the communication unit 810 is configured to receive first transmission configuration indicator (TCI) information, where the first TCI information is used to determine a first TCI state, or the first TCI information is used to determine a second TCI state and a third TCI state;
in a case where the first TCI information is used to determine the first TCI state, the communication unit 810 is further configured to transmit a first physical uplink control channel (PUCCH), and the processing unit 820 is configured to determine an effective time of the first TCI state according to a time domain position of the first PUCCH; where the first PUCCH carries hybrid automatic repeat request (HARQ) feedback information corresponding to m transmissions of a first channel, or the first PUCCH carries HARQ feedback information corresponding to a last transmission of m transmissions of a first channel, and m is a positive integer; or
in a case where the first TCI information is used to determine the second TCI state and the third TCI state, the communication unit 810 is further configured to transmit a second PUCCH and a third PUCCH, and the processing unit 820 is configured to determine an effective time of the second TCI state and an effective time of the third TCI state according to a time domain position of the second PUCCH and a time domain position of the third PUCCH; where the second PUCCH carries HARQ feedback information corresponding to all transmissions associated with the second TCI state in m transmissions of a first channel, and the third PUCCH carries HARQ feedback information corresponding to all transmissions associated with the third TCI state in the m transmissions of the first channel; or, the second PUCCH carries HARQ feedback information corresponding to a last transmission associated with the second TCI state in m transmissions of a first channel, and the third PUCCH carries HARQ feedback information corresponding to a last transmission associated with the third TCI state in the m transmissions of the first channel, and m is a positive integer.

In some embodiments, in the case where the first TCI information is used to determine the first TCI state, the first TCI state is a joint TCI state, or the first TCI state is an uplink TCI state, or the first TCI state is a downlink TCI state.

In some embodiments, in a case where the first TCI state is the uplink TCI state, the first TCI information is further used to determine a downlink TCI state; or in a case where the first TCI state is the downlink TCI state, the first TCI information is further used to determine an uplink TCI state.

In some embodiments, the processing unit 820 is specifically configured to:
determine that the first TCI state is effective at a first time domain position;
where the first time domain position is a starting position of a first time unit, and the first time unit is first one time unit after a first time interval after a last symbol occupied by the first PUCCH.

In some embodiments, in the case where the first TCI information is used to determine the second TCI state and the third TCI state,
the second TCI state and the third TCI state are two uplink TCI states, and the second TCI state and the third TCI state are respectively applied to different transmission layers of an uplink channel, or the second TCI state and the third TCI state are respectively applied to different repetition transmissions of an uplink channel; or
the second TCI state and the third TCI state are two downlink TCI states, and the second TCI state and the third TCI state are respectively applied to different transmission layers of a downlink channel, or the second TCI state and the third TCI state are respectively applied to different repetition transmissions of a downlink channel; or
the second TCI state and the third TCI state are two joint TCI states, and the second TCI state and the third TCI state are respectively applied to different transmission layers of an uplink channel and/or a downlink channel, or the second TCI state and the third TCI state are respectively applied to different repetition transmissions of an uplink channel and/or a downlink channel.

In some embodiments, the processing unit 820 is specifically configured to:
if the time domain position of the second PUCCH is located after the time domain position of the third PUCCH, determine that the second TCI state is effective at a second time domain position and the third TCI state is not effective, where the second time domain position is a starting position of a second time unit, and the second time unit is first one time unit after a second time interval after a last symbol occupied by the second PUCCH; or
if the time domain position of the second PUCCH is located after the time domain position of the third PUCCH, determine that the third TCI state is effective at a third time domain position and the second TCI state is not effective, where the third time domain position is a starting position of a third time unit, and the third time unit is first one time unit after a third time interval after a last symbol of the third PUCCH.

In some embodiments, the second time interval and the third time interval are associated with different spatial parameters, respectively.

In some embodiments, the processing unit 820 is specifically configured to:
determine that the second TCI state is effective at a fourth time domain position, and the third TCI state is effective at a fifth time domain position;
where the fourth time domain position is a starting position of a fourth time unit, and the fourth time unit is first one time unit after a fourth time interval after a last symbol occupied by the second PUCCH; the fifth time domain position is a starting position of a fifth time unit, and the fifth time unit is first one time unit after a fifth time interval after a last symbol occupied by the third PUCCH.

In some embodiments, the fourth time interval and the fifth time interval are associated with different spatial parameters, respectively.

In some embodiments, the time unit includes at least one of: a slot, a symbol, a frame, or a subframe.

In some embodiments, the first channel is a physical downlink shared channel (PDSCH).

In some embodiments, the aforementioned communication unit may be a communication interface or transceiver, or an input/output interface of a communication chip or a system on chip.

The aforementioned processing unit may be one or more processors.

It should be understood that the terminal device 800 according to the embodiments of the present application may correspond to the terminal device of the method embodiments of the present application, and the above or other operations and/or functions of each unit in the terminal device 800 is respectively to implement the corresponding processes of the terminal device in the method 400 shown in FIG. 9, which are not repeated herein for the sake of brevity.

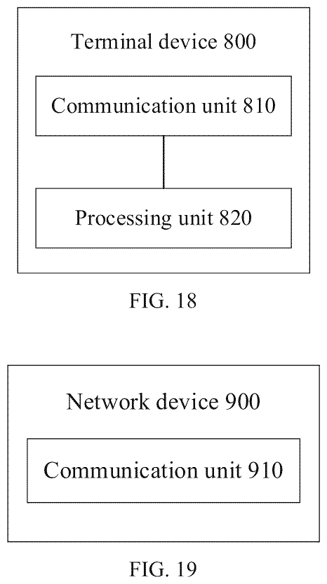

FIG. 19 illustrates a schematic block diagram of a network device 900 according to the embodiments of the present application. As shown in FIG. 19, the network device 900 includes:
a communication unit 910, configured to first transmission configuration indicator (TCI) information, where the first TCI information is used to determine a first TCI state, or the first TCI information is used to determine a second TCI state and a third TCI state;
in a case where the first TCI information is used to determine the first TCI state, the communication unit 910 further configured to receive a first physical uplink control channel (PUCCH); where the first PUCCH carries hybrid automatic repeat request (HARQ) feedback information corresponding to m transmissions of a first channel, or the first PUCCH carries HARQ feedback information corresponding to a last transmission of m transmissions of a first channel, an effective time of the first TCI state is determined based on a time domain position of the first PUCCH, and m is a positive integer; or
in a case where the first TCI information is used to determine the second TCI state and the third TCI state, the communication unit 910 further configured to receive a second PUCCH and a third PUCCH; where the second PUCCH carries HARQ feedback information corresponding to all transmissions associated with the second TCI state in m transmissions of a first channel, and the third PUCCH carries HARQ feedback information corresponding to all transmissions associated with the third TCI state in the m transmissions of the first channel; or, the second PUCCH carries HARQ feedback information corresponding to a last transmission associated with the second TCI state in m transmissions of a first channel, and the third PUCCH carries HARQ feedback information corresponding to a last transmission associated with the third TCI state in the m transmissions of the first channel, an effective time of the second TCI state and an effective time of the third TCI state are determined based on a time domain position of the second PUCCH and a time domain position of the third PUCCH, and m is an positive integer.

In some embodiments, in the case where the first TCI information is used to determine the first TCI state, the first TCI state is a joint TCI state, or the first TCI state is an uplink TCI state, or the first TCI state is a downlink TCI state.

In some embodiments, in a case where the first TCI state is the uplink TCI state, the first TCI information is further used to determine a downlink TCI state; or
in a case where the first TCI state is the downlink TCI state, the first TCI information is further used to determine an uplink TCI state.

In some embodiments, in the case where the first TCI information is used to determine the first TCI state, the first TCI state is effective at a first time domain position, where the first time domain position is a starting position of a first time unit, and the first time unit is first one time unit after a first time interval after a last symbol occupied by the first PUCCH.

In some embodiments, in the case where the first TCI information is used to determine the second TCI state and the third TCI state,
the second TCI state and the third TCI state are two uplink TCI states, and the second TCI state and the third TCI state are respectively applied to different transmission layers of an uplink channel, or the second TCI state and the third TCI state are respectively applied to different repetition transmissions of an uplink channel; or,
the second TCI state and the third TCI state are two downlink TCI states, and the second TCI state and the third TCI state are respectively applied to different transmission layers of a downlink channel, or the second TCI state and the third TCI state are respectively applied to different repetition transmissions of a downlink channel; or
the second TCI state and the third TCI state are two joint TCI states, and the second TCI state and the third TCI state are respectively applied to different transmission layers of an uplink channel and/or a downlink channel, or the second TCI state and the third TCI state are respectively applied to different repetition transmissions of an uplink channel and/or a downlink channel.

In some embodiments, in the case where the first TCI information is used to determine the second TCI state and the third TCI state, if the time domain position of the second PUCCH is located after the time domain position of the third PUCCH, the second TCI state is effective at a second time domain position and the third TCI state is not effective, where the second time domain position is a starting position of a second time unit, and the second time unit is first one time unit after a second time interval after a last symbol occupied by the second PUCCH; or
in the case where the first TCI information is used to determine the second TCI state and the third TCI state, if the time domain position of the second PUCCH is located after the time domain position of the third PUCCH, the third TCI state is effective at a third time domain position and the second TCI state is not effective, where the third time domain position is a starting position of a third time unit, and the third time unit is first one time unit after a third time interval after a last symbol of the third PUCCH.

In some embodiments, the second time interval and the third time interval are associated with different spatial parameters, respectively.

In some embodiments, in the case where the first TCI information is used to determine the second TCI state and the third TCI state, the second TCI state is effective at a fourth time domain position, and the third TCI state is effective at a fifth time domain position;
where the fourth time domain position is a starting position of a fourth time unit, and the fourth time unit is first one time unit after a fourth time interval after a last symbol occupied by the second PUCCH; the fifth time domain position is a starting position of a fifth time unit, and the fifth time unit is first one time unit after a fifth time interval after a last symbol occupied by the third PUCCH.

In some embodiments, the fourth time interval and the fifth time interval are associated with different spatial parameters, respectively.

In some embodiments, the time unit includes at least one of: a slot, a symbol, a frame, or a subframe.

In some embodiments, the first channel is a physical downlink shared channel (PDSCH).

In some embodiments, the aforementioned communication unit may be a communication interface or transceiver, or an input/output interface of a communication chip or a system on chip

It should be understood that the network device 900 according to the embodiments of the present application may correspond to the network device of the method embodiments of the present application, and the above or other operations and/or functions of each unit in the network device 900 is respectively to implement the corresponding processes of the network device in the method 500 shown in FIG. 15, which are not repeated herein for the sake of brevity.

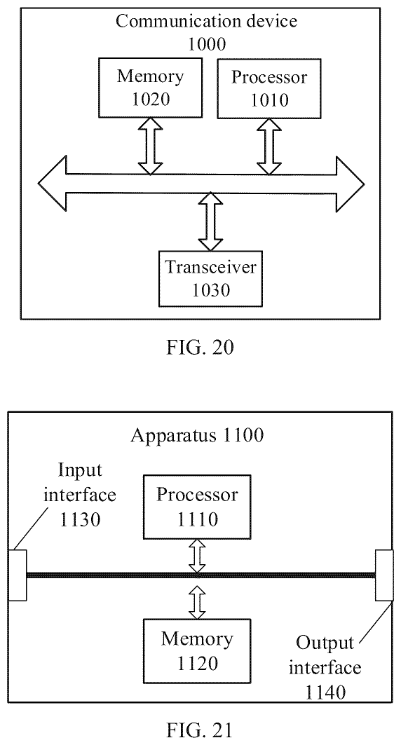

FIG. 20 is a schematic structure diagram of a communication device 1000 provided in the embodiments of the present application. The communication device 1000 shown in FIG. 20 includes a processor 1010, and the processor 1010 may invoke and execute a computer program from a memory, to implement the method in the embodiments of the present application.

In some embodiments, as shown in FIG. 20, the communication device 1000 further includes a memory 1020. Herein, the processor 1010 may invoke and execute a computer program from the memory 1020 to implement the method in the embodiments of the present application.

Herein, the memory 1020 may be a separate device independent from the processor 1010, or may also be integrated into the processor 1010.

In some embodiments, as shown in FIG. 20, the communication device 1000 may also include a transceiver 1030, and the processor 1010 may control the transceiver 1030 to communicate with other devices, and specifically, to transmit information or data to other devices, or receive information or data transmitted by other devices.

Herein, the transceiver 1030 may include a transmitter and a receiver. The transceiver 1030 may further include antennas, and the number of antennas may be one or more.

In some embodiments, the communication device 1000 may specifically be the network device of the embodiments of the present application, and the communication device 1000 may implement the corresponding procedure implemented by the network device in the various methods of the embodiments of the present application, which will not be repeated here for the sake of brevity.

In some embodiments, the communication device 1000 may specifically be the terminal device of the embodiments of the present application, and the communication device 1000 may implement the corresponding procedure implemented by the terminal device in the various methods of the embodiments of the present application, which will not be repeated here for the sake of brevity.

FIG. 21 is a schematic structural diagram of an apparatus of the embodiments of the present application. The apparatus 1100 shown in FIG. 21 includes a processor 1110, the processor 1110 may invoke and execute a computer program from a memory to implement the method in the embodiments of the present application.

In some embodiments, as shown in FIG. 21, the apparatus 1100 may further include a memory 1120. Herein, the processor 1110 may invoke and execute a computer program from the memory 1120 to implement the method in the embodiments of the present application.

Herein, the memory 1120 may be a separate device independent from the processor 1110, or may also be integrated into the processor 1110.

In some embodiments, the apparatus 1100 may further include an input interface 1130.

Herein, the processor 1110 may control the input interface 1130 to communicate with other devices or chips, and specifically, the input interface 1130 may acquire information or data sent by other devices or chips.

In some embodiments, the apparatus 1100 may further include an output interface 1140.

Herein, the processor 1110 may control the output interface 1140 to communicate with other devices or chips, and specifically, the output interface 1140 may output information or data to other devices or chips.

In some embodiments, the apparatus may be applied to the network device in the embodiments of the present application, and the apparatus may implement the corresponding procedure implemented by the network device in the various methods of the embodiments of the present application, which will not be repeated here for the sake of brevity.

In some embodiments, the apparatus may be applied to the terminal device in the embodiments of the present application, and the apparatus may implement the corresponding procedure implemented by the terminal device in the various methods of the embodiments of the present application, which will not be repeated here for the sake of brevity.

In some embodiments, the apparatus mentioned in the embodiments of the present application may also be a chip. For example, it may be a system on chip, a system chip, a chip system or a system-on-chip chip, etc.

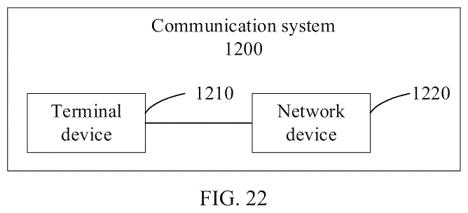

FIG. 22 is a schematic block diagram of a communication system 1200 provided in the embodiments of the present application. As shown in FIG. 22, the communication system 1200 includes a terminal device 1210 and a network device 1220.

Herein, the terminal device 1210 may be configured to implement the corresponding functions implemented by the terminal device in the aforementioned methods, and the network device 1220 may be configured to implement the corresponding functions implemented by the network device in the aforementioned methods, which will not be repeated here for the sake of brevity.

It should be understood that the processor in the embodiments of the present application may be an integrated circuit chip and have a processing capability of signals. In the implementation process, various steps of the above method embodiments may be completed by an integrated logic circuit of hardware in the processor or an instruction in a software form. The above processor may be a general-purpose processor, a Digital Signal Processor (DSP), an Application Specific Integrated Circuit (ASIC), a Field Programmable Gate Array (FPGA) or other programmable logic devices, a discrete gate or transistor logic device, a discrete hardware component. Various methods, steps and logical block diagrams disclosed in the embodiments of the present application may be implemented or performed. A general-purpose processor may be a microprocessor, or the processor may also be any conventional processor, etc. The steps of the method disclosed in combination with the embodiments of the present application may be directly embodied as being performed and completed by a hardware decoding processor, or by using a combination of hardware and software modules in the decoding processor. The software module may be located in the mature storage medium in the art such as the random memory, the flash memory, the read-only memory, the programmable read-only memory or electrically erasable programmable memory, the register. The storage medium is located in the memory, and the processor reads the information in the memory and completes the steps of the above methods in combination with its hardware.

It may be understood that, the memory in the embodiments of the present application may be a volatile memory or a non-volatile memory, or may include both volatile and non-volatile memories. Herein, the non-volatile memory may be a Read-Only Memory (ROM), a programmable read-only memory (Programmable ROM, PROM), an erasable programmable read-only memory (Erasable PROM, EPROM), an electrically erasable programmable read-only memory (Electrically EPROM, EEPROM) or a flash memory. The volatile memory may be a Random Access Memory (RAM), which is used as an external cache. Through illustrative, rather than limiting, illustration, many forms of RAMs are available, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchronous link dynamic random access memory (Synchlink DRAM, SLDRAM) and a direct rambus random access memory (Direct Rambus RAM, DR RAM). It should be noted that the memory of the system and the method described herein is intended to include, but not limited to, these and any other suitable types of memories.

It should be understood that the above memory is exemplary but not limiting illustration, e.g., the memory in embodiments of the present application may also be a static Random Access Memory (static RAM, SRAM), a Dynamic Random Access Memory (dynamic RAM, DRAM), a synchronous DRAM (SDRAM), a double data rate SDRAM (DDR SDRAM), an enhanced SDRAM (ESDRAM), a synch link DRAM (SLDRAM), and a Direct Rambus RAM (DR RAM), etc. That is, the memory in the embodiments of the present application is intended to include, but not limited to, these and any other suitable types of memories.

The embodiments of the present application further provide a non-transitory computer readable storage medium for storing a computer program.

In some embodiments, the non-transitory computer readable storage medium may be applied to the network device in the embodiments of the present application, and the computer program causes a computer to perform the corresponding procedure implemented by the network device in the various methods of the embodiments of the present application, which will not be repeated here for the sake of brevity.

In some embodiments, the non-transitory computer readable storage medium may be applied to the terminal device in the embodiments of the present application, and the computer program causes a computer to perform the corresponding procedure implemented by the terminal device in various methods of the embodiments of the present application, which will not be repeated here for the sake of brevity.

The embodiments of the present application further provide a computer program product including a computer program instruction.

In some embodiments, the computer program product may be applied to the network device in the embodiments of the present application, and the computer program instruction causes a computer to perform the corresponding procedure implemented by the network device in the various methods of the embodiments of the present application, which will not be repeated here for the sake of brevity.

In some embodiments, the computer program product may be applied to the terminal device in the embodiments of the present application, and the computer program instruction causes a computer to perform the corresponding procedure implemented by the terminal device in various methods of the embodiments of the present application, which will not be repeated here for the sake of brevity.

The embodiments of the present application further provide a computer program.

In some embodiments, the computer program may be applied to the network device in the embodiments of the present application, the computer program when being executed on a computer, causes the computer to perform the corresponding procedure implemented by the network device in various methods of the embodiments of the present application, which will not be repeated here for the sake of brevity.

In some embodiments, the computer program may be applied to the terminal device in the embodiments of the present application, the computer program when being executed on a computer, causes the computer to perform the corresponding procedure implemented by the terminal device in various methods of the embodiments of the present application, which will not be repeated here for the sake of brevity.

Those ordinary skilled in the art may realize that units and algorithm steps of the examples described in combination with the embodiments disclosed herein can be implemented in electronic hardware or in a combination of computer software and electronic hardware. Whether these functions are performed by way of hardware or software depends on a specific application and a design constraint of the technical solution. A skilled person may use different methods for each specific application, to implement the described functions, but such implementation should not be considered beyond the scope of the present application.

It may be clearly understood by those skilled in the art that, for convenience and brevity of the description, the specific working procedures of the system, the apparatus and the unit described above may refer to the corresponding procedures in the above method embodiments, which will not be repeated here.

In the several embodiments provided by the application, it should be understood that, the disclosed systems, apparatus, and method may be implemented in other ways. For example, the apparatus embodiments described above are only schematic, for example, division of the units is only division of logical functions, and there may be other division methods in an actual implementation, for example, a plurality of units or components may be combined or integrated into another system, or some features may be ignored or not performed. On the other hand, the coupling or direct coupling or communicative connection between each other as shown or discussed may be indirect coupling or communicative connection of apparatus or units via some interfaces, which may be electrical, mechanical, or in other forms.

The units illustrated as separate components may be or may not be physically separated, and the components shown as units may be or may not be physical units, that is, they may be located in one place, or may be distributed onto a plurality of network units. A part or all of the units may be selected according to actual needs, to implement the purpose of the schemes of the embodiments.

In addition, the various functional units in the various embodiments of the present application may be integrated into one processing unit, or the various units may exist physically separately, or two or more units may be integrated into one unit.

If the described functions are implemented in the form of a software functional unit and sold or used as an independent product, they may be stored in a non-transitory computer readable storage medium. For this understanding, the technical solution of the present application essentially, or a part of the technical solution that contributes to the prior art, or a part of the technical solution, may be embodied in the form of a software product, and the computer software product is stored in a storage medium, and includes a plurality of instructions for enabling a computer device (which may be a personal computer, a server, or a network device, etc.) to perform all or some of steps of the methods described in the various embodiments of the present application.

And, the storage medium mentioned above includes a USB flash drive (U disk), a mobile hard disk, a Read-Only Memory (ROM), a Random Access Memory (RAM), a diskette, or an optical disk, and various mediums that may store program codes.

The above content is only specific implementations of the present application, but the protection scope of the present application is not limited thereto, and any skilled familiar with this technical field may easily think of changes or substitutions within the technical scope disclosed in the present application, which should be all covered within the protection scope of the present application. Therefore, the protection scope of the present application should be subject to the protection scope of the claims.

What is claimed is:

1. A method for wireless communication, comprising:
receiving, by a terminal device, first transmission configuration indicator (TCI) information, wherein the first TC information is used to determine a first TCI state, or the first TCI information is used to determine a second TCI state and a third TCI state;
transmitting, by the terminal device, a first physical uplink control channel (PUCCH) at a first time domain position, wherein the first PUCCH carries hybrid automatic repeat request (HARQ) feedback information associated with the first TCI information;
in a case where the first TCI information is used to determine the first TCI state, determining, by the terminal device, whether to apply the first TCI state to transmit a first channel or signal after a second time domain position; or
in a case where the first TCI information is used to determine the second TCI state and the third TCI state, determining, by the terminal device, whether to apply the second TCI state to transmit a first channel or signal after a third time domain position, and whether to apply the third TCI state to transmit the first channel or signal after a fourth time domain position;
wherein the second time domain position is a starting position of a first time unit, and the first time unit is first one time unit after a first time interval after a last symbol occupied by the first PUCCH; the third time domain position is a starting position of a second time unit, and the second time unit is first one time unit after a second time interval after the last symbol occupied by the first PUCCH; and the fourth time domain position is a starting position of a third time unit, and the third time unit is first one time unit after a third time interval after the last symbol occupied by the first PUCCH.

2. The method according to claim 1, wherein,
in the case where the first TCI information is used to determine the first TCI state, the first TCI state is a joint TCI state, or the first TCI state is an uplink TCI state, or the first TCI state is a downlink TCI state.

3. The method according to claim 2, wherein,
in a case where the first TCI state is the uplink TCI state, the first TCI information is further used to determine a downlink TCI state; or
in a case where the first TCI state is the downlink TCI state, the first TCI information is further used to determine an uplink TCI state.

4. The method according to claim 2, wherein determining, by the terminal device, whether to apply the first TC state to transmit the first channel or signal after the second time domain position, comprises:
if a starting position of a first transmission of m transmissions of the first channel or signal is located before the second time domain position, determining, by the terminal device, that second TCI information is applied to all the m transmissions of the first channel or signal, wherein the second TCI information is TCI information applied by the terminal device before the second time domain position, and m is a positive integer.

5. The method according to claim 1, wherein,
in the case where the first TCI information is used to determine the second TCI state and the third TCI state, the second time interval is associated with a first spatial parameter, and the third time interval is associated with a second spatial parameter.

6. The method according to claim 5, wherein,
the second TCI state and the third TCI state are two uplink TCI states, and the second TCI state and the third TCI state are respectively applied to different transmission layers of an uplink channel, or the second TCI state and the third TCI state are respectively applied to different repetition transmissions of an uplink channel; or
the second TCI state and the third TCI state are two downlink TCI states, and the second TCI state and the third TCI state are respectively applied to different transmission layers of a downlink channel, or the second TCI state and the third TCI state are respectively applied to different repetition transmissions of a downlink channel; or
the second TCI state and the third TCI state are two joint TCI states, and the second TCI state and the third TC state are respectively applied to different transmission layers of an uplink channel and/or a downlink channel, or the second TCI state and the third TCI state are respectively applied to different repetition transmissions of an uplink channel and/or a downlink channel.

7. The method according to claim 5, wherein determining, by the terminal device, whether to apply the second TCI state to transmit the first channel or signal after the third time domain position, and whether to apply the third TCI state to transmit the first channel or signal after the fourth time domain position, comprises:
if a first transmission associated with the first spatial parameter in m transmissions of the first channel or signal is before the third time domain position, determining, by the terminal device, that the m transmissions of the first channel or signal all apply second TCI information; or
if a first transmission associated with the second spatial parameter in m transmissions of the first channel or signal is before the fourth time domain position, determining, by the terminal device, that the m transmissions of the first channel or signal all apply second TCI information;
wherein the second TCI information is TCI information applied by the terminal device before an earlier time domain position in the third time domain position and the fourth time domain position in time domain, and m is a positive integer;
or
determining, by the terminal device, whether to apply the second TCI state to transmit the first channel or signal after the third time domain position, and whether to apply the third TCI state to transmit the first channel or signal after the fourth time domain position, comprises:
determining, by the terminal device, to discard a transmission located after the third time domain position and associated with the first spatial parameter in m transmissions of the first channel or signal, and to discard a transmission located after the fourth time domain position and associated with the second spatial parameter in the m transmissions of the first channel or signal;
wherein m is a positive integer.

8. The method according to claim 1, wherein,
the first TCI information is carried by downlink control information (DCI), or the first TCI information is carried by a media access control layer control element (MAC CE); and
in a case where the first TCI information is carried by the DCI, the first time interval is Yi time units; or, in a case where the first TCI information is carried by the MAC CE, the first time interval is an effective time of the MAC CE; or
the second time interval is Y₂ time units, and/or the third time interval is Y₃ time units;
wherein Y₁, Y₂ and Y₃ are all positive integers.

9. The method according to claim 8, wherein,
Y₁ is agreed by a protocol, or Y₁ is configured by a network device according to a minimum beam application time supported by the terminal device; or
Y₂ and Y₃ are agreed by a protocol, or Y₂ and Y₃ are configured by the network device according to a minimum beam application time supported by the terminal device.

10. The method according to claim 1, wherein,
the time unit comprises at least one of: a slot, a symbol, a frame, or a subframe.

11. A network device, comprising: a processor and a memory, wherein the memory is configured to store a computer program, the processor is configured to invoke and execute the computer program stored in the memory, to cause the network device to perform:
transmitting first transmission configuration indicator (TCI) information, wherein the first TCI information is used to determine a first TCI state, or the first TCI information is used to determine a second TCI state and a third TCI state;
receiving a first physical uplink control channel (PUCCH) transmitted by a terminal device at a first time domain position, wherein the first PUCCH carries hybrid automatic repeat request (HARQ) feedback information associated with the first TCI information;
in a case where the first TCI information is used to determine the first TCI state, determining whether the terminal device applies the first TCI state to transmit a first channel or signal after a second time domain position; or
in a case where the first TCI information is used to determine the second TCI state and the third TCI state, determining whether the terminal device applies the second TCI state to transmit a first channel or signal after a third time domain position, and whether the terminal device applies the third TCI state to transmit the first channel or signal after a fourth time domain position;
wherein the second time domain position is a starting position of a first time unit, and the first time unit is first one time unit after a first time interval after a last symbol occupied by the first PUCCH; the third time domain position is a starting position of a second time unit, and the second time unit is first one time unit after a second time interval after the last symbol occupied by the first PUCCH; and the fourth time domain position is a starting position of a third time unit, and the third time unit is first one time unit after a third time interval after the last symbol occupied by the first PUCCH.

12. The network device according to claim 11, wherein,
in the case where the first TCI information is used to determine the first TCI state, the first TCI state is a joint TCI state, or the first TCI state is an uplink TCI state, or the first TCI state is a downlink TCI state.

13. The network device according to claim 12, wherein,
in a case where the first TCI state is the uplink TCI state, the first TCI information is further used to determine a downlink TCI state; or
in a case where the first TCI state is the downlink TCI state, the first TCI information is further used to determine an uplink TCI state.

14. The network device according to claim 12, wherein determining whether the terminal device applies the first TCI state to transmit the first channel or signal after the second time domain position, comprises:
if a starting position of a first transmission of m transmissions of the first channel or signal is located before the second time domain position, determining that the terminal device applies second TC information in all the m transmissions of the first channel or signal, wherein the second TCI information is TCI information applied by the terminal device before the second time domain position, and m is a positive integer.

15. The network device according to claim 11, wherein,
in the case where the first TCI information is used to determine the second TCI state and the third TCI state, the second time interval is associated with a first spatial parameter, and the third time interval is associated with a second spatial parameter.

16. The network device according to claim 15, wherein,
the second TCI state and the third TCI state are two uplink TCI states, and the second TCI state and the third TCI state are respectively applied to different transmission layers of an uplink channel, or the second TCI state and the third TCI state are respectively applied to different repetition transmissions of an uplink channel; or
the second TCI state and the third TCI state are two downlink TCI states, and the second TCI state and the third TCI state are respectively applied to different transmission layers of a downlink channel, or the second TCI state and the third TCI state are respectively applied to different repetition transmissions of a downlink channel; or
the second TCI state and the third TCI state are two joint TCI states, and the second TCI state and the third TC state are respectively applied to different transmission layers of an uplink channel and/or a downlink channel, or the second TCI state and the third TCI state are respectively applied to different repetition transmissions of an uplink channel and/or a downlink channel.

17. The network device according to claim 15, wherein determining whether the terminal device applies the second TCI state to transmit the first channel or signal after the third time domain position, and whether the terminal device applies the third TCI state to transmit the first channel or signal after the fourth time domain position, comprises:
if a first transmission associated with the first spatial parameter in m transmissions of the first channel or signal is before the third time domain position, determining that the terminal device applies second TCI information in all the m transmissions of the first channel or signal; or
if a first transmission associated with the second spatial parameter in m transmissions of the first channel or signal is before the fourth time domain position, determining that the terminal device applies second TCI information in all the m transmissions of the first channel or signal;
wherein the second TC information is TCI information applied by the terminal device before an earlier time domain position in the third time domain position and the fourth time domain position in time domain, and m is a positive integer;
or
determining whether the terminal device applies the second TCI state to transmit the first channel or signal after the third time domain position, and whether the terminal device applies the third TCI state to transmit the first channel or signal after the fourth time domain position, comprises:
determining that the terminal device discards a transmission located after the third time domain position and associated with the first spatial parameter in m transmissions of the first channel or signal, and discards a transmission located after the fourth time domain position and associated with the second spatial parameter in the m transmissions of the first channel or signal;
wherein m is a positive integer.

18. The network device according to claim 11, wherein,
the first TCI information is carried by downlink control information (DCI), or the first TCI information is carried by a media access control layer control element (MAC CE); and
in a case where the first TCI information is carried by the DCI, the first time interval is Yi time units; or, in a case where the first TCI information is carried by the MAC CE, the first time interval is an effective time of the MAC CE; or
the second time interval is Y₂ time units, and/or the third time interval is Y₃ time units;
wherein Y₁, Y₂ and Y₃ are all positive integers.

19. The network device according to claim 18, wherein,
Y₁ is agreed by a protocol, or Y₁ is configured by a network device according to a minimum beam application time supported by the terminal device; or
Y₂ and Y₃ are agreed by a protocol, or Y₂ and Y₃ are configured by the network device according to a minimum beam application time supported by the terminal device.

20. A terminal device, comprising: a processor and a memory, wherein the memory is configured to store a computer program, the processor is configured to invoke and execute the computer program stored in the memory, to cause the terminal device to perform:
receiving first transmission configuration indicator (TCI) information, wherein the first TCI information is used to determine a first TCI state, or the first TCI information is used to determine a second TCI state and a third TCI state;
transmitting a first physical uplink control channel (PUCCH) at a first time domain position, wherein the first PUCCH carries hybrid automatic repeat request (HARQ) feedback information associated with the first TCI information;
in a case where the first TCI information is used to determine the first TCI state, determining whether to apply the first TCI state to transmit a first channel or signal after a second time domain position; or
in a case where the first TCI information is used to determine the second TCI state and the third TCI state, determining whether to apply the second TCI state to transmit a first channel or signal after a third time domain position, and whether to apply the third TCI state to transmit the first channel or signal after a fourth time domain position;
wherein the second time domain position is a starting position of a first time unit, and the first time unit is first one time unit after a first time interval after a last symbol occupied by the first PUCCH; the third time domain position is a starting position of a second time unit, and the second time unit is first one time unit after a second time interval after the last symbol occupied by the first PUCCH; and the fourth time domain position is a starting position of a third time unit, and the third time unit is first one time unit after a third time interval after the last symbol occupied by the first PUCC.
